(19) United States
(12) Patent Application Publication
(10) Pub. No.: US 2002/0107761 A1
(43) Pub. Date: Aug. 8, 2002

(54) Methods and systems for improved channel sales support in electronic commerce

(76) Inventors: Donald Kark, Highlands Ranch, CO (US); Eddie D. Tuggle, Parker, CO (US); Jon C. Mottram, Denver, CO (US); Thomas R. Anderson, Aurora, CO (US)

Correspondence Address: ATTEN: STUART T. LANGLEY, HOGAN & HARTSON L.L.P., ONE TABOR CENTER, 1200 SEVENTEENTH STREET, SUITE 1500, DENVER, CO, 80202, US

(21) Appl. No.: 09/734,911

(22) Filed: Dec. 10, 2000

(51) Int. Cl. G06F 17/60; G06F 7/00; G06F 17/30; G06F 12/00

(52) U.S. Cl. 705/27; 705/7; 707/9; 707/10; 707/203

(57) ABSTRACT

Methods and associated systems for multi-layered channel marketing catalog generation and maintenance. A plurality of hierarchically related product/service catalogs are maintained so as to maintain commonality with regard to information contained in the catalogs and to permit customization at each layer. Information from a plurality of manufacturer catalogs are provided and integrated into a single master industry catalog Channel marketing partners of the several manufacturers extract information from the industry catalog for the particular manufacturers with whom they have established marketing agreements. The extracted information is then presented as a channel partner catalog to customers/users of the channel partner. Resellers having established relationships with one or more channel partners extract information from the channel partners' catalogs to create a reseller's catalog. Still lower layers of the marketing channel extract information from the next higher layer catalog to generate their own custom layer catalog. Each layer catalog includes processing to periodically review the higher layer's catalog to identify new or revised information and may accept or reject the updates for inclusion in their layer. Revision index values are preferably used in each layered catalog to identify updates and additions. In the preferred embodiment, information is exchanged between the catalogs using standard XML messaging formats and protocols.

### BACKGROUND OF THE INVENTION

1. Field of the Invention

The invention relates to electronic commerce and in particular relates to methods and systems for improved channel sales support in a vendors Internet-based electronic commerce.

2. Discussion of Related Art

The Internet has rapidly evolved from a network primarily used for interconnection of research and academic sites to a global medium for transacting commerce. Commercial transactions include the exchange of data for fees, publishing and dissemination of information for fees, advertising and commercial sales of goods and services. Such commercial transactions include both transaction between businesses (often referred to as “B2B” for “business to business”) and between a business and a consumer (often referred to as “B2C” for “business to consumer”).

In the sale of goods (or services) over the Internet, a buyer typically reviews information about goods (or services) available from a vendor. The information is usually presented to the buyer from a Web server node connected to the Internet. The user/buyer uses a Web browser client to review the product/service information. Most such present day Web sites also permit the buyer to purchase the goods/services of interest by selecting particular goods from the information presented and providing purchasing information (billing or payment information and shipping information).

Most present Web sites offering such goods or services for sale present the information in the form of a catalog. Such a format is comfortable and well-known to the buyer in that it is similar to traditional commercial transactions.

Many traditional commercial transactions involve “channel marketing.” Channel marketing involves a vendor acting cooperatively with “channel partners” to market their goods and services. A channel partner provides assistance to the vendor to market the goods and services in a particular “channel” or segment of the marketplace. Such channel partners are often commonly referred to as distributors, resellers or retailers in various marketing contexts. A “reseller” is a general term of art in the marketing sector that refers to an entity that resells goods/services of another provider. Sometimes a channel partner may be referred to as a reseller and in other contexts a seller of goods/services provided by a channel partner may be referred to as a reseller. Other terms are frequently used in this context. For example, the term “storefront” is often used in reference to a sales outlet of a channel partner. Similarly, “channel partner location” is another term often used to refer to a sales location of the goods/services offered by a channel partner. As used herein, “channel partner location”, “storefront” and “reseller” are intended to refer to a seller or sales location for sales of goods/services provided by a channel partner.

In traditional commerce transactions outside the Internet, a vendor works hard to establish and maintain good relationships with such channel partners. An aspect of such relationships involves cooperative marketing programs that enable a channel partner to derive benefit from the industry reputation of the vendor. It is also common for such vendor/channel partner relationships for the vendor to grant exclusivity to a channel partner for a particular channel/segment of the marketplace. Frequently the vendor supplies standard marketing materials for a channel partner to utilize in their specific, targeted marketing efforts. A common element of such standard marketing materials may include catalogs or other pricing and promotional materials. Each channel partner therefore benefits from use of standard marketing materials and the association with the vendors reputation thereby generated in the minds of consumers.

The standardized marketing materials are often provided to channel partners in a form that permits customization of the marketing materials by the channel partner so that the channel partner may integrate the materials with those of other vendors whose goods/services are resold by the channel partner.

It is also common in such channel marketing arrangements that the vendor directs potential sales contacts to appropriate channel partners. If a consumer directly contacts the vendor for product information, the requested information may be provided by the vendor but further contact with the prospective customer will be directed to an appropriate channel partner.

In the Internet electronic commerce (e-commerce) environment, such channel relationships have been difficult in terms of how to best apply the Internet medium to such channel relationships. Cooperative marketing efforts manifested in the form of standardized marketing materials are more difficult to manage in the Internet context. It is common that the vendor and channel partner each have separate Web server systems. Each distinct Web server system may have a very different appearance as well as differing substance relating to the products or pricing.

Current online catalogs are primarily designed as one-to-many relationships. In Marketplaces, Manufacturer Agency models, and other online ventures, there is generally a concept of a centrally maintained and priced catalog that serves as the main ordering instrument for a manufacturer or a distributor.

In many B2B systems now, a manufacturer or distributor catalog is presented to each channel partner for ordering purposes. However, these catalogs do nothing to help the indirect channel partner to sell to his customers. A model of this sales style is shown in FIG. 1. Each of several manufacturers 100 has its own electronic catalog 102. Every channel partner 104 . . . 108 accesses the catalog 102 of each manufacturer 100 with whom the channel partner does business.

Properties and drawbacks of this model include:

There is only one catalog to be viewed, belonging to the manufacturer or distributor. There is generally no process for having the catalog customized available to the reseller or their customers reflecting what the reseller actually sells.

Resellers may see custom pricing based on their contracts with the manufacturer or distributor, however there is no way to automatically leverage this pricing for the reseller to sell online to their customers.

Resellers may order through the single manufacturer or distributor. However, a different system may be in place for each manufacturer or distributor the reseller deals with. There is no aggregation of the purchasing process.

This is a tool for the manufacturers and distributors to sell to channel partners (ignoring the fact that the real destination of the goods/services is generally to the channel partner's customers). There is no support for the channel partner to sell their own goods/services to their customers.

Other catalogs, supported by the content portals that sell “storefronts”, can allow individual businesses to set up their catalogs and sell online. As used herein a “portal” is an Internet site designed to attract users based upon particular content available through that site. However in this case, there is no assistance or help for each reseller. They must completely and manually set up their own catalog, maintain it, and price it. Most importantly there is no incentive for portals to proactively drive business to the storefront. Rather, the portals are neutral in this regard with respect to preferences for manufacturers, channel partners or other layers of the marketing model. This technique results in a heavy maintenance and marketing burden on the channel partner (generally a small business), and has no support for related business locations that each want to have their own stores, to leverage their relationships. These catalogs to support this model are generally “spun-off” as independent catalogs, again really delivering a one-to-many cataloging solution to each partner.

This portal model is shown in FIG. 2 wherein a portal site 200 provides a “front-end” interface to present the catalogs 203, 205 and 207 of multiple channel partners 202,204 and 206, respectively to users (not shown) of the portal site.

Properties and drawbacks of this model include:

There is no supply chain support at all. It is up to the channel partner to keep their catalog current for content and pricing. It is also up to the channel partner to accept orders from their store and re-enter them into their fulfillment systems.

Pricing is done completely manually. For large numbers of SKU's (which may change price daily in some industries), simply ensuring that prices are correct puts a huge burden on the channel partner's human resources.

Portals generally have no incentive to drive business to a specific channel partner based on locality or a need to serve customers in their physical area. As such having such a storefront has been likened to having a “billboard in the basement”. The store may exist, but no one is driving business to it.

With the advent of electronic commerce “marketplaces”, there are finally ways for the channel partner to use one interface to order from multiple suppliers. Some marketplaces are now expressing the idea of “many-to-many” catalogs that allow several manufacturers to contribute catalog items to an industry catalog. The industry catalog can then be presented to multiple channel partners so that they can “buy” items from the manufacturers (or distributors). Some distributors offer this type of cataloging to their reseller partners, such as TechData. Other marketplaces, such as Ariba, also have this model. Unfortunately even this model does nothing to help the channel partners themselves sell to their customers. These solutions only allow the channel partners to buy product or services from specific vendors or manufacturers.

An example of an e-commerce marketplace is shown in FIG. 3 where a central industry catalog 300 provides information and pricing for a plurality of manufacturers (302 and 304) and distributors (306 and 308). Channel partners 310 and 312 then access this central industry catalog 300 to obtain information and order from any of the participating manufacturers or distributors.

Properties and drawbacks of this model include:

There is still only one catalog to be viewed, but it does exist as a consolidated catalog for the marketplace. There is still generally no process for having the catalog customized available to the reseller or their customers reflecting what the reseller actually sells.

Resellers may see custom pricing based on their relationship with the marketplace and its suppliers. However, there is no way to automatically leverage this pricing for the reseller to sell online to their customers.

Resellers may order through the marketplace. There is aggregation of the purchasing process. However the manufacturers' individual brands get compromised.

This is a tool for a set of manufacturers and distributors to sell to channel partners (still ignoring the fact that the real destination of the goods/services is generally to the channel partner's customers). There is no support for the channel partner to sell their own goods/services to their customers.

Some “agency” models allow channel partners to present a single manufacturer catalog to their clients/customers on the Internet to serve as a facade for a channel partner store. In these cases, the channel partner themselves have little or no control over the items being sold or the pricing of the items. They are paid by the central store with a commission monthly, and the revenue does not actually flow through the channel partner's top-line. The channel partner has no ability to add their own goods or services, and has no input as to what is being offered to their customers. This model is not conducive to the channel partner providing “solutions”, as the channel partner rarely gets the chance to develop their own relationships selling their overall line of goods and services. This is really a modified “direct” store model, not commerce for the indirect channel itself. It has many of the drawbacks of direct sales models, including the fact that channel partner customers are no longer solely in a relationship with the channel partner, they begin developing direct relationships with the suppliers, threatening the indirect channel.

The main business drawbacks of the known state of the art in online cataloging are:

The vast majority of catalogs out there are a one-to-many architecture. These catalogs were originally designed for direct commerce from one entity to many customers. There is no support (or capacity to add effective support) for an entire indirect supply chain consisting of multiple (hundreds to thousands) of resellers.

Architecturally, solutions built for a one-to-many relationship are not effectively extended to a many-to-many architecture, let alone the many-to-many-to-many architecture necessary for true commerce through the indirect channels.

Even the many-to-many catalogs do not extend the supply chain far enough down to reach the customers. They are primarily used to link multiple manufacturers to multiple channel partners, allowing each channel partner to buy from a manufacturer. This model cannot be effectively extended without the sophisticated revision control features. Such systems contain neither the efficiency for channel partners to maintain their catalogs easily, nor the sellside features necessary to provide an effective, pleasant buying experience for the channel partners' customers.

It is therefore a problem for e-commerce channel marketing relationships to utilize common, consistent marketing materials while permitting more customizing and “branding” of the various layers of marketing in channel marketing schemes. A need exists for improved channel marketing arrangements in e-commerce and in particular for the use of common or standardized marketing materials in such channel marketing relationships that still permits significant customization and branding by the channel partners in reselling to end-users.

### SUMMARY OF THE INVENTION

The present invention solves the above and other problems, thereby advancing the state of the useful arts, by providing improved support for channel marketing in e-commerce channel marketing relationships. In particular, the present invention overcomes these problems by providing support for the indirect channel partner network at all layers. As such, it provides a fully integrated set of capabilities to manage the supply chain all the way out to the end-customers of each channel partner. The catalog system of the present invention preferably supports five distinct levels of catalog in an integrated way. Each level can have any number of customized catalog versions to support the channel partner network. Manufacturer catalog information is preferably fed to the master catalog of the present invention in industry-standard XML formats. The Open Catalog Format (OCF) standard is exemplary of one such standard XML format that may be used in association with the present invention. This rich format allows for the incorporation of catalog categories, items, pictures, and parameters into the manufacturer level. Multiple manufacturer catalogs are preferably then incorporated into a industry master catalog through a set of calls to the catalog API.

In particular, the present invention preferably provides for the following five defined levels of catalogs and relationships among them.

### The Manufacturer Level

If the manufacturer catalog does not exist yet, the catalog is created from scratch, and it becomes a new catalog in that level. If the manufacturer catalog already exists, the new catalog is treated as an update to the existing catalog.

For updates, there are two options: either the product is new to the catalog, or the product has changed. It is determined for each product if the product already exists. If it does exist, the item is updated in the database. If it does not exist, a new item is created in the database. Each product contains two incremental counters. One revision number is incremented if the manufacturer description is changed (the data revision), the other is incremented if the price is changed (the price revision). By maintaining two such revision counters, revision information regarding pricing alone may be updated independent of revision information regarding other product information. The independence of these two update mechanisms helps in enabling automated procedures for “flow-through” updating of information through layers of the channel marketing structures. In particular, pricing information may be updated on a periodic basis with fully automated procedures used to integrate recent price changes from the higher layer catalogs. By contrast, product information may be updated less frequently or may be updated in a more manual process to permit the catalog owner to select particular products or to re-define categories or other attributes associated with the products selected from the higher layer catalog.

For deletions, the manufacturers provide a list of items to be deleted, based on Stockkeeping Unit (SKU) number. These products are moved to a category that is designated to be a holding area for items to be deleted.

### The Industry Level

The industry catalog is created by merging all known manufacturer catalogs together (if they exist). Preferably a timed event (i.e., a Unix-style “cron” event) checks to see if new manufacturers have been created, or if the current manufacturers that are part of the industry catalog have changed. The original merge (and any further update) copies the information from the parent catalogs to the industry catalog, preserving the “parent” product id and the “parent” revision numbers.

### Updated Items

At the timed event, there is a check for the “parent” catalog looking for the items in the manufacturer level that are parents of the items in the industry level. The check pulls all items with a revision number greater than this product's current revision number.

### New Items

If there are new items in the manufacturer catalogs, they are presented as new items in the industry level catalog.

### Deleted Items

If there are items that have been deleted, they are presented as deleted items. When they are selected to be deleted, they are moved to a holding area (a “.trash” category of records) for items being deleted much the way users are familiar with a “trash” folder in present computing systems.

### The Partner level, Reseller Location level, and the Custom Level

These levels are preferably created as copies of a catalog from the level above. That is, the partner level catalogs are preferably created as copies of the industry master catalog, the reseller location catalogs are preferably created as copies of a partner catalog, and so on. Using this copy method, the system is able to maintain the parent-child relationship based on a catalog id.

In maintaining these lower levels of catalogs, they are all updated in essentially the same manner as the industry level except that they only check the parent from which they were created. That is, the partner level catalogs only check the industry level catalog for changes/modifications. The reseller location level catalogs only check the partner level catalogs for changes, and the custom catalogs only check the reseller location catalogs for changes.

Items that are modified are presented to be updated. The user may accept or reject the changes offered, but the revision numbers are modified to those of the parent product.

### A Day in the Life of a Catalog

As an example of the modification process, presume an item in one of the manufacturer level catalogs was modified. In this case, the revision number would change from an initial number of 1 to 2. The next time the industry level catalog is checked for modifications, the parent's revision number will currently be greater than the one in the industry level item. That item would be checked to be reviewed for modifications. If the owner of the industry catalog liked the new changes, they could accept the product the way it is. It would then be sent to the industry catalog as an update to that product. The revision numbers would be updated to the revision numbers, so that the parent revision numbers would be the same as the current parent revision numbers. If the owner of the industry catalog decided not to update the item, the current revision numbers would not have changed, so any further catalogs (like partner level catalogs) would not get notified about modifications. If the owner of the industry catalog decided to update the item, the current revision numbers would be incremented, and the owner of the partner catalog would eventually go through the same iterations as the owner of the industry catalog.

Through the hierarchical maintenance of multiple levels of such catalogs, each catalog layer may be automatically updated from updates of the next higher layer of catalog. Further, the contents of each layer may be customized for the purposes of interacting with the next lower layer of the hierarchy of the marketing channel.

Further aspects of the catalog systems and methods of the present invention enable filtering of presentation of a catalog information based upon factors such as the particular portal used to enter the catalog or based upon other criteria of the viewer of the catalog. A “stoplist” data structure allows the definition of particular products to be excluded from view by a user of the catalog based on such criteria of the user.

More specifically, the present invention provides in a first aspect, a system for catalog manipulation in an electronic commerce channel marketing scenario having a plurality of manufacturers and a plurality of channel partners. The system comprises a plurality of manufacturer catalogs, each manufacturer catalog including information regarding products provided by a corresponding manufacturer; an industry catalog generated from selected information received from the manufacturer catalogs; and a plurality of channel partner catalogs generated from selected information received from the industry catalog. Each channel partner catalog is associated with a corresponding channel partner of the plurality of channel partners.

Another aspect further comprises a plurality of reseller catalogs generated from selected information received from the channel partner catalogs. Each reseller catalog is associated with a corresponding reseller of the plurality of resellers. Another aspect provides that the various catalogs each have a plurality of entries representing the selected information received from the respective higher layer catalogs. Each entry of includes a revision index value. A selector mechanism determines which information in the higher layer catalog is newer than information in the lower layer catalog in accordance with the revision index values in each catalog. An integrator mechanism for selectively integrates into the each catalog information determined to be newer in the corresponding higher layer catalog. The revision index values may include price revision index value and may include product data revision index values.

A stoplist structure associated with the database identifies products in corresponding catalogs to be excluded from presentation to a requesting user based on portal used for accessing the database by the user.

Methods of the present invention provide for generating and maintaining product catalogs in a channel marketing scenario having a plurality of manufacturers and a plurality of channel partners. One method includes the steps of: providing an industry master catalog having an aggregation of a plurality of manufacturer catalogs including information regarding products or services available from a corresponding manufacturer; and selectively copying portions of the industry master catalog to a plurality of channel partner catalogs, each representing goods or services of a manufacturer available from a corresponding channel partner.

Further methods provide for detecting changed information in the manufacturer catalogs; and periodically updating the industry master catalog from the changed information. In particular, the detection of changed information includes the steps of: determining whether information in the manufacturer catalogs is newer than corresponding information in the industry master catalog based on revision index values in catalogs. The revision index values include price revision index values and product data revision index values. Related methods further provide for detecting changed information in the industry master catalog; and periodically updating the channel partner catalogs from the changed information in the industry master catalog.

Another method provides for the step of periodically updating and scaling pricing information for all products in the catalogs based on corresponding pricing information in the higher layer catalogs and based on price scaling information in the catalog to be updated.

Other methods further comprise the steps of locating information in a catalog in response to a request from a user using an identified portal; filtering the located information to remove restricted information based on the identified portal; and returning the filtered information to the user.

The above structures, systems, and methods are applicable to any number of layers of catalogs in channel marketing. In particular, the layers below the channel partner, including resellers, storefronts, channel partner locations and end customer all use essentially identical catalog structures, systems and methods. All layers, and in particular the end customer layer, access the various catalogs for the end purpose of selecting and purchasing goods and services offered by the corresponding marketing entity.

The above, and other features, aspects, and advantages of the present invention will become apparent from the following descriptions and attached drawings.

### BRIEF DESCRIPTION OF THE DRAWINGS

FIG. 1 is a block diagram of a single manufacturer relating to multiple channel partners as presently known in the art.

FIG. 2 is a block diagram of a portal that provides access to many channel partners as presently known in the art.

FIG. 3 is a block diagram of a marketplace in which many manufacturers relate to many channel partners as presently known in the art.

FIG. 4 is a block diagram of the multiple layers of many-to-many-to-many relationships in channel marketing and the hierarchical databases of the present invention that support such a layered marketing model.

FIG. 5 is a graphical depiction of a preferred exemplary database schema for a catalog database in accordance with the present invention.

FIG. 6 is a flowchart describing a method of the present invention for a user to manually update product and other information in a catalog database of the present invention.

FIG. 7 is a flowchart describing a method of the present invention for creating a new child (lower layer) catalog of the present invention from a parent (higher layer) catalog of the present invention.

FIG. 8 is a flowchart describing a method of the present invention for detecting changes in a parent catalog layer of the present invention.

FIG. 9 is a flowchart describing a method of the present invention for bulk updates of pricing information in a child catalog of the present invention from a parent catalog of the present invention.

FIG. 10 is a flowchart describing a method of the present invention for applying the stoplist features of the present invention to presentation of products from a catalog of the present invention.

FIGS. 11 through 24 are segments of a drawing that collectively depict a class diagram of an exemplary preferred embodiment of a Java implemented catalog object in accordance with the present invention.

FIG. 25 is a flowchart describing a method of the present invention for permitting a user to manually and selectively integrate into a child catalog of the present invention all changes located in a parent catalog of the present invention.

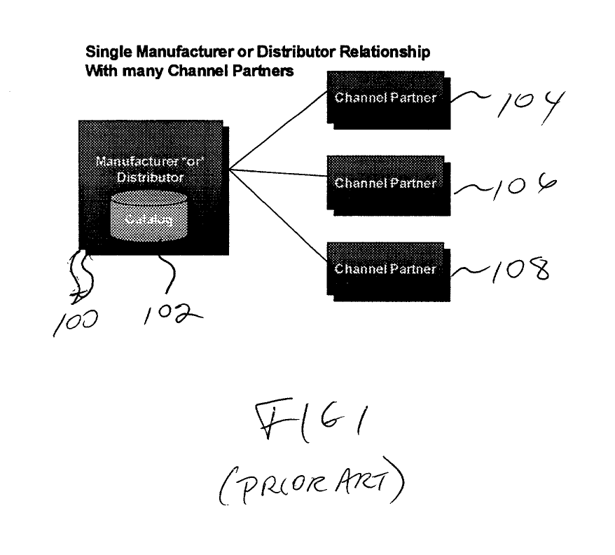

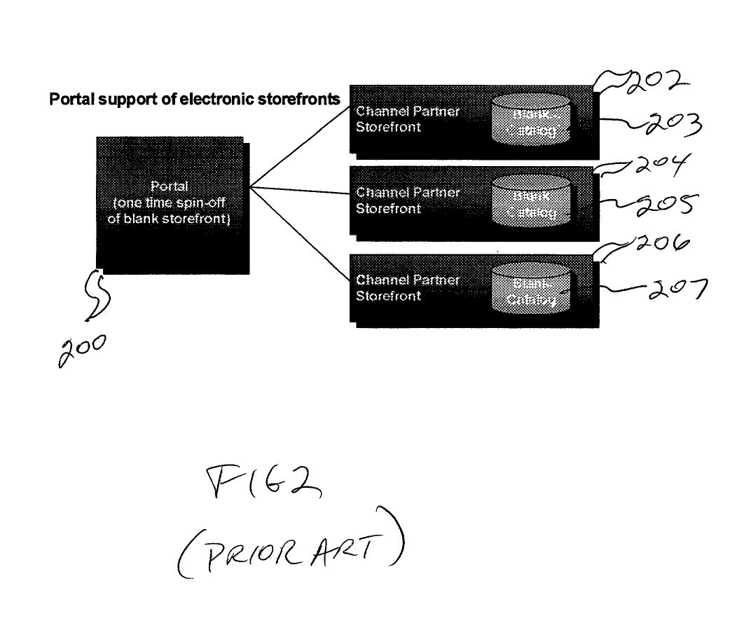

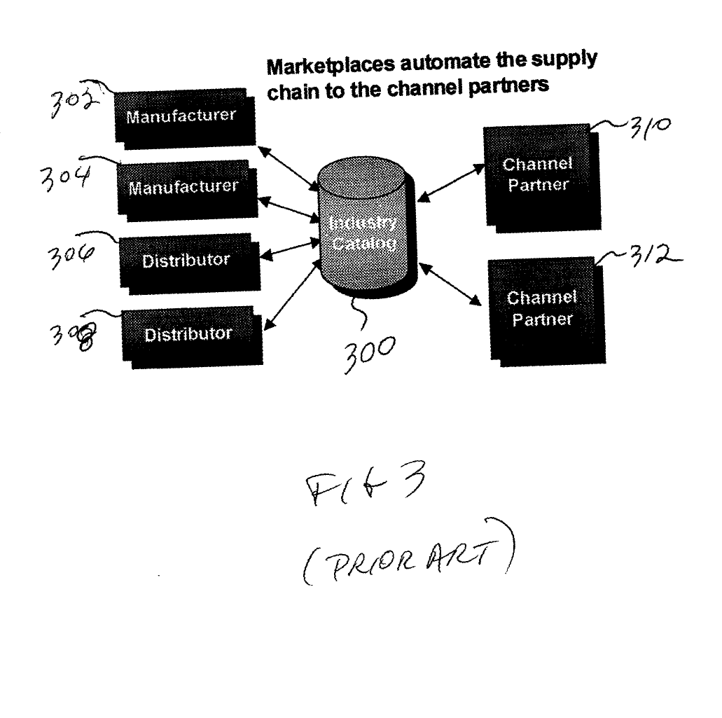

### DETAILED DESCRIPTION OF THE PREFERRED EMBODIMENTS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

### Hierarchical Catalog System

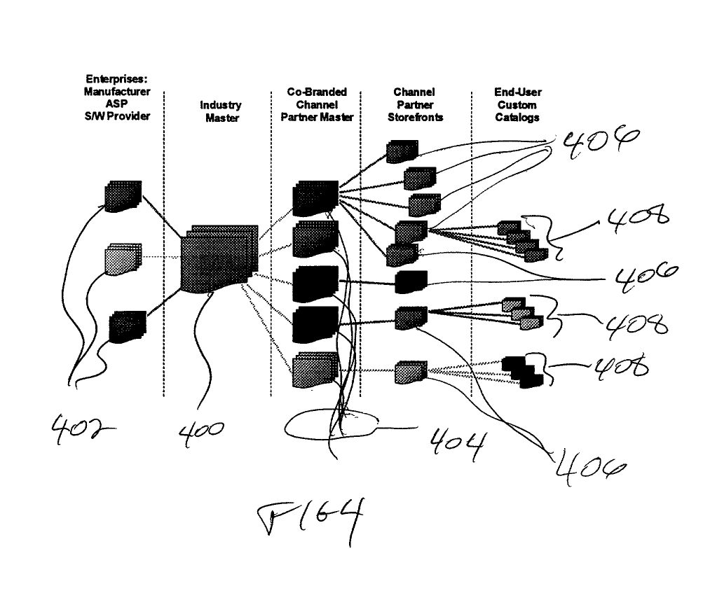

FIG. 4 is a block diagram of a hierarchical catalog structure of the present invention reflecting the structure of e-commerce channel marketing. A plurality of manufacturer catalogs 402 are provided by producers of goods/services. Information from such manufacturer catalogs 402 is integrated into an industry master catalog 400. Channel partners of the several manufacturers download information from the industry master catalog 400 into their own channel partner master catalogs 404. Each channel partner loads information into its channel partner master catalog 404 for each of the various manufacturers with whom the channel partner has a business relationship. Each channel partner storefront (or “reseller”) downloads information from a corresponding channel partner master catalog 404 into it's own channel partner storefront catalog 406. Lastly, custom catalogs 408 may be created for particular markets or customers by extracting information from a corresponding channel partner storefront catalog 406.

Those skilled in the art will recognize that any number of marketing layers may be used in conjunction with the catalog structures and methods of the present invention. The structure of FIG. 4 is therefore intended merely as exemplary of a typical channel marketing scheme. Key to the invention is the hierarchical nature of the catalogs mirroring the structure of a channel partner marketing approach and the various processes enabled by such structures.

### Catalog Database

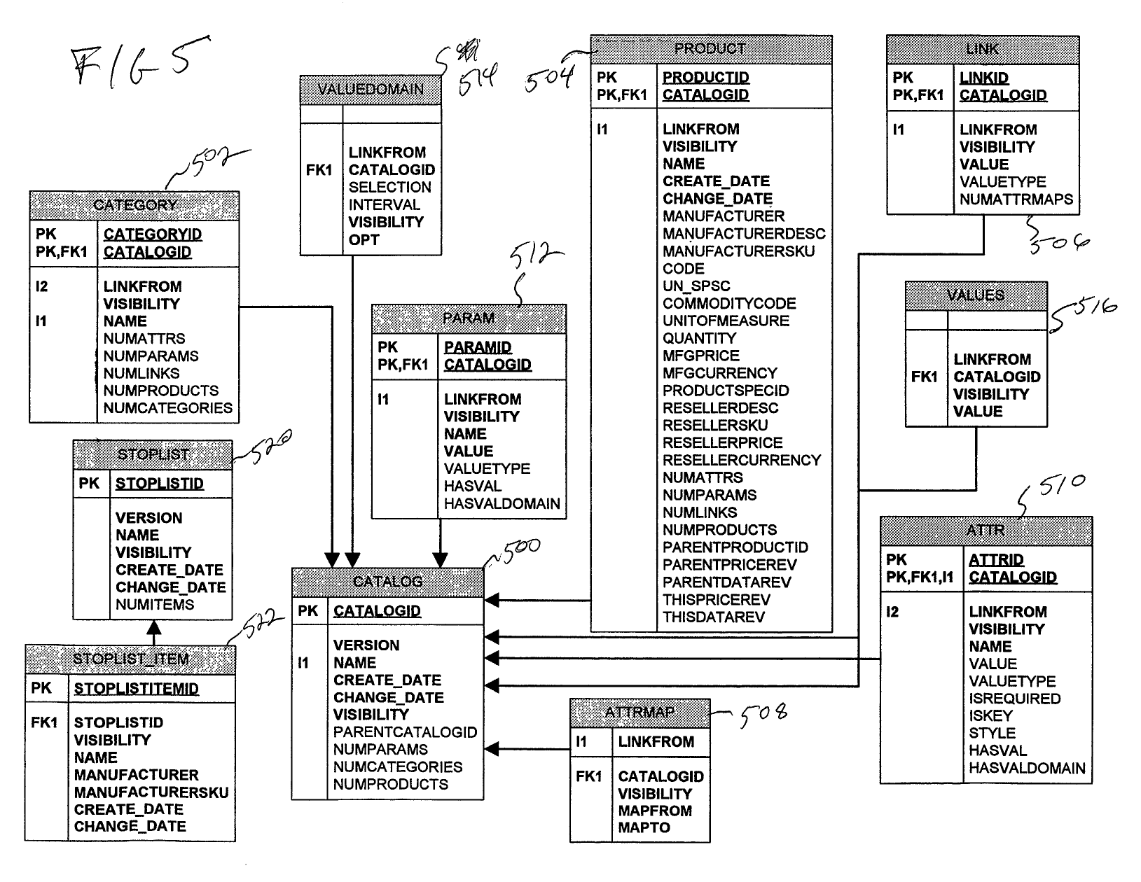

FIG. 5 is a block diagram representing a database schema of a catalog in accordance with the present invention. The preferred embodiment of such a database is implemented as a relational database (RDBMS) to improve performance. Those skilled in the art will recognize that the database representing a catalog may also be advantageously implemented as an object-oriented database (OODBMS). Present OODBMS products suffer from performance problems relative to present RDBMS products. Functionally, such a database may be implemented in any data storage model that permits flexible relationships to be represented and permits rapid access to achieve desired performance goals.

Further, those skilled in the art will recognize that the particular structures and tables shown in FIG. 5 are intended as one exemplary embodiment of a database structure that may be utilized to implement the hierarchical catalog features of the present invention. A wide variety of equivalent structures and table organizations may be selected as well-known design choices by those skilled in the art.

Further, as noted above, a number of data interchange standards such as OCF have evolved to provide for standard data content in e-commerce catalogs and marketing approaches. The database structures shown in FIG. 5 are exemplary of one embodiment that includes several of the data fields and types defined by the OCF standard. Other fields and features are added and still others may be included to enable compatibility with still other data interchange standards. Those skilled in the art will therefore recognize that the structures and fields show in FIG. 5 are similar to such standards but are not defined or required by any particular data interchange standard.

Each catalog in the hierarchical layers of catalogs provided by the present invention is preferably an instantiation of the structure of FIG. 5. Since the application of each catalog may vary depending on the intended use by its owner, a number of fields are relevant to certain layers of the channel marketing model and not to others. Such fields are simply used in appropriate layers of catalogs and ignored in others.

All records associated with a particular catalog are generally associated by a CATALOGID key value. A single catalog owner at a single location may have a plurality of catalogs defined and maintained for various lower layer marketing partners. The CATALOGID in each record of each table helps to associate the related records from any one of such multiple catalogs.

The CATALOG table 500 contains a record for each catalog defined by the owner of the enterprise. In addition to the CATALOGID field, a VERSION and NAME field help identify the particular catalog in accordance with the owner's convention. For example, the catalog may be the “Clothing” catalog by name and the “Fall 2000” catalog by version. Though the NAME field may preferably be used as a common index on the table, it is not assured to be unique and therefore is not the preferred key for the table. The PARENTCATALOGID contains the CATALOGID value of the parent catalog from which this catalog was derived. As used herein, a “parent” catalog refers to a catalog at the next higher layer of the marketing hierarchy of catalogs and a “child” catalog refers to a catalog at the next lower layer of the marketing catalog hierarchy.

A number of fields in the CATALOG table are common to several other tables. Such common fields will be noted here in reference to the CATALOG table and may be presumed to have similar functions and values as used in other tables. Such common fields include the following. CREATE_DATE and CHANGE_DATE fields are used to track creation and changes to records of the table for auditing purposes. In the preferred embodiment, automated features (i.e., “triggers” in an Oracle RDMBS) are used to automatically update these dates. When a record is created, a trigger automatically inserts the present date in the CREATE_DATE field. When a record is updated, another automatic trigger inserts the present date in the CHANGE_DATE field. The VISIBILITY field is defined to permit test data to be integrated with live data in a particular implementation of the catalog. Test data may be flagged with a value in VISIBILITY to preclude it's display in a production environment. NUMXXX fields in the table are used to maintain counts of various attributes of the record and other related records. For example, NUMCATEGORIES identifies the total number of product categories in the catalog while NUMPRODUCTS identifies the total number of products in the highest level catalog. Specifically, in the preferred embodiment, NUMPRODUCTS is a count of the number of products in this catalog that are not included in any category as described below (i.e., 0 if all products in the catalog are included in categories as described further below). A similar field in the CATEGORY table described below stores a similar count value for convenience of access. Such values can be derived from the records of the entire catalog database but are more rapidly determined by maintaining them as fields in the database file.

A catalog may include any number of product categories. The defined categories are entered as records in the CATEGORY table 502. As above, the NAME field provides an owner defined name for the category defined by each record and is used as an index for the table. The CATEGORYID is a unique value used as a key for the table and the CATALOGID links each record to the particular catalog in which it is included. The LINKFROM field indicates another category, if any, from which this record represents a sub-category. Such linking of categories permits recursive definition of the categories to provide a richer definition of categories and related sub-categories. For example, “FOOD” may be the name of a first category of products and “FROZEN FOOD” may be the name of a related sub-category of products. The LINKFROM field of a highest level category (one which is not a sub-category of another category) indicates a NULL or other invalid value to so indicate a top level category.

A catalog typically includes a plurality of products. The defined products are entered as records in the PRODUCT table 504. As above, the NAME field provides an owner defined name for the product defined by each record. The PRODUCTID is a unique value used as a key for the table and the CATALOGID links each record to the particular catalog in which it is included. The LINKFROM field in this table indicates another product, if any, from which this record represents a sub-product or sub-component. Such linking of products permits recursive definition of the products to provide a richer definition of products and related sub-products. For example, “TABLE SAW” may be the name of a product and “SAW BLADE” may be the name of a related sub-product. The LINKFROM field of a highest level product (one which is not a sub-product of another product) indicates the CATEGORYID value of the category, if any, to which it is linked, or, if not included in a category, the LINKFROM field for such a product indicates a NULL or other invalid value to so indicate a top level product.

A significant number of fields in the PRODUCT table 504 provide details of the product including standard product codes, pricing information, quantity and unit of measure, etc. Such fields may include:

| | |
|---|---|
| Field | Description |

| | |
|---|---|
| MANUFACTURER | Name of manufacturer |
| MANUFACTURERDESC | Manufacturer's description |
| MANUFACTURERSKU | Manufacturer's SKU |
| CODE | Universal Product Code |
| UN_SPSC | United Nations Standard Product |
| | and Service Code |
| COMMODITYCODE | Commodity Product Code |
| UNITOFMEASURE | Unit of measure for product |
| QUANTITY | Quantity of product |
| MFGPRICE | Manufacturer's suggested price |
| MFGCURRENCY | Manufacturer's currency units |
| PRODUCTSPECID | Product specification ID |
| RESELLERDESC | Reseller's description |
| RESELLERSKU | Reseller's SKU |
| RESELLERPRICE | Reseller's price |
| RESELLERCURRENCY | Reseller's currency units |

NUMXXX fields, the CREATEDATE field, the CHANGEDATE field and the VISIBILITY field are used for convenience and testing of the database.

Remaining fields are used to track revisions of pricing and other data relating to products. Revision information is used to selectively update data in a catalog from its parent catalog. In particular, the PARENTPRODUCTID field indicates the PRODUCTID of the corresponding product in the parent catalog. THISPRICEREV and THISDATAREV indicate the current revision index number of the product pricing and product information, respectively, for the product in this catalog. Corresponding entries in the parent catalog (i.e., THISPRICEREV and THISDATAREV in the parent catalog's corresponding product entry) indicate the current revision index number of the corresponding data in the parent catalog product entry. PARENTPRICEREV and PARENTDATAREV in this catalog product entry indicate the current revision index for product pricing and product information, respectively, in the parent catalog at the last time the related information was updated from the parent catalog. The price and product data revision fields are also referred to herein as price revision index and product data revision index, respectively.

One skilled in the art will recognize that appropriately formatted date and time stamp values may be used as equivalent revision tracking indices. More generally, any monotonic increasing or decreasing value may be used for this function. Such design choices for implementing these field are well-known to those in the art.

As noted above, revision tracking information relating to product pricing is preferably maintained separately from revision tracking information pertaining to other product data. This separation provides for separate product pricing updates independent of other product data updates. This is desirable because pricing information may be updated more frequently and even using automated procedures whereas other product data is updated less frequently and often with manual intervention and discretion on the part of the catalog owner. Further details of methods involved in use of these fields for purposes of updating a catalog are provided herein below.

Those skilled in the art will recognize that the structure of FIG. 5 as recited thus far enables, but does not require, the copied information from a parent catalog to be customized in the child catalog as desired by the owner of the child catalog. The copying of such information from a parent to a child provides the desired goal of maintaining centralized control of the catalog information (hierarchical control to be more precise) while the ability to customize provides for the additional goal of “branding” to enable each layer of the marketing chain to customize the appearance and substance of the information presented. One clear example is that the categories defined in the CATEGORY table may be copied from a parent catalog to retain the identical substance and presentation style. In the alternative, the owner of a child catalog may choose to ignore the categories of the parent catalog and create their own categories. Products copied from the parent may then be associated with different categories as desired by the owner of the child catalog.

Other tables shown in FIG. 5 further enhance the functionality and richness of the catalog product information. In particular, both products and categories may have attributes associated therewith. Examples of attributes for a product might be color or size. Attributes may be similarly applied to a category. For example, a clothing category might be “FABRIC” and the value of that attribute might be “COTTON.” Such an attribute applied to a category implies all products within that category share that same attribute unless an individual product overrides that attribute value. A clothing product may similarly have such a FABRIC attribute and attribute value of COTTON. A product might also have a different FABRIC attribute value though it also is shown to be included in a category with the COTTON attribute value. In such a case, the product attribute value overrides the corresponding attribute value that may be associated with a category in which the product is included.

The ATTR table 510 contains records with attributes defined for a related product or category. An ATTRID field provides a unique ID value for each attribute record and is used as a key in the table. The CATALOGID field, as above, is a key in the table and relates all records in the table to a particular catalog. A LINKFROM field indicates the PRODUCTID or CATEGORYID to which the attribute record is related. A NAME field provides a user-defined (owner-defined) name to the attribute. The VISIBILITY field is a test vehicle as described above with respect to other tables. The CATALOGID and LINKFROM fields may be used as indices on the table. ISREQUIRED, ISKEY and STYLE are fields that help define the usage of the attribute, i.e., whether it is required, etc.

Attribute records in the table have one or more values associated therewith. If the values are simply defined, the HASVAL field of the record indicates that the VALUETYPE and VALUE fields of the record define the possible values. The VALUETYPE field indicates whether the attribute has a single value, a list of enumerated values, or a more complex set of possible ranges or domains of possible values. If VALUETYPE indicates that the attribute record includes a single possible value for the attribute, then the permitted value is stored in the VALUE field. If VALUETYPE indicates that the attribute has a list of possible values, entries in the VALUES table 516 are linked to the attribute record to specify the list of possible values. Specifically, the LINKFROM field of the VALUES table 516 entries corresponding to the attribute record have the ATTRID value to indicate the linkage. As with other tables discussed above, the VALUES table 516 entries include a CATALOGID field as a key value to associate the records with a particular catalog. The VISIBILITY field of the VALUES table 516 entries is a test vehicle as described above. The VALUE field of each VALUES table 516 entry has one of the list of possible values of the related attribute record.

The ATTR table 510 records may alternatively indicate that the record has a more complex range of values that are permitted. The HASVALDOMAIN field of the attribute record indicates that records in the VALUEDOMAIN table 514 define the range(s) of permissible values of the attribute record. The VALUEDOMAIN table 514 records include a CATALOGID field as a key to associate the records of the table with a particular catalog and a VISIBILITY field as defined above. The LINKFROM field of the VALUEDOMAIN table 514 records link back to the ATTRID value of the related attribute record. The SELECTION, INTERVAL and OPT fields of the VALUEDOMAIN table 514 records define the complex range of attribute values permissible for the related attributes record.

Catalogs, categories and products may all have parameters associated with each record of the corresponding tables. The PARAM table 512 records store the parameters of related catalog, category or product records. Each record of the PARAM table 512 includes a unique identifier PARAMID field as a key value. In addition, as above, each record includes a CATALOGID field, a VISIBILITY field and a NAME field for similar purposes to those described above with respect to other tables of the database. The LINKFROM field of the PARAM table 512 records indicates the CATALOGID, CATEGORYID or PRODUCTID of the related record of the corresponding tables, The VALUE, VALUETYPE, HASVAL and HASVALDOMAIN fields are used to define the values of the corresponding parameter table entry as described above with respect to the ATTR table 510.

The LINK table 506 is used to define marketing linkages and ties among products. For example, it may be useful in a marketing catalog to link an electronic toy in the catalog with batteries because users of the catalog who purchase such a toy are likely to purchase the required batteries. This is distinct from the hierarchical or recursive linkage of products within the PRODUCTS table 504 as indicative of products that include or contain other products. The LINK table 506, by contrast, suggests related products that may be useful if a user selects one product for purchase. A LINKID key field in the LINK table 506 records uniquely identifies each record. As above, the CATALOGID key field and the VISIBILITY field are included for associating the records with a particular catalog and for testing purposes, respectively. The LINKFROM field relates the record to a product in the PRODUCT table 504. VALUETYPE and VALUE fields identify the type of link defined by the record. For example, a type of link may be “cross-selling” to associate related products in the catalog as described above. A list of linked products is defined by related records in the ATTRMAP table 508. The LINKFROM field of the ATTRMAP table 508 records indicates the LINKID value of related records in the LINK table 506. As above, the CATALOGID key field and the VISIBILITY field are included for associating the records with a particular catalog and for testing purposes, respectively. The MAPFROM and MAPTO fields identify specific fields that can associate the product with a related product. In particular, the MAPFROM field indicates a field name used to identify a related product and the MAPTO field indicates the value of the field identified by MAPFROM to be used to identify a related product. For example, MAPFROM could have a value of “SKU” and MAPTO could have a value of “975374” to indicate that the product is related to another product that has an SKU field value of 975374.

Two additional tables are defined in the database though not necessarily associated with a particular catalog. The STOPLIST table 520 and STOPLIST_ITEM table 522 in combination define products that are not intended to be presented to users depending upon external factors such as the portal used to access the catalog. For example, it is common in e-commerce marketing arrangements that users accessing a catalog from a particular portal should see a preference for a particular brand or brands of goods to the exclusion of other goods. Such a preference is defined by a record in the STOPLIST table 520. The record includes a unique value STOPLISTID key field and VERSION, NAME, VISIBILITY, CREATE_DATE and CHANGE_DATE fields as defined above. A user accessing the catalog, for example, by a particular portal would invoke inspection of a corresponding STOPLIST table 520 record, if any, to filter products not intended for presentation to that user over that particular portal. In the preferred embodiment, all catalogs physically reside at a service provider's site such that all access is centralized and controlled by a catalog access service. The service determines through means outside of the present invention what particular portal is used to access the database and then looks for records in the STOPLIST table 520 that indicate the presence of items not to be presented to users of the catalog accessing the catalogs through the corresponding portal. In this preferred embodiment, the STOPLIST table 520 and associated items in the STOPLIST_ITEM table 522 are defined by the catalog service provider in conjunction with the portal management.

One or more records in the STOPLIST_ITEM table 522 are related to the STOPLIST table 520 record by the STOPLISTID key field. Each record in the STOPLIST_ITEM table 522 includes a unique key STOPLISTITEMID field. The VISIBILITY, NAME, MANUFACTURER, MANUFACTURERSKU, CREATE_DATE and CHANGE_DATE fields are as defined above with respect to other tables. Specifically, the MANUFACTURER and MANUFACTURERSKU fields are used to identify products that are to be precluded from presentation to the user of any catalog in the database. Products in the PRODUCT table 504 having the same MANUFACTURERSKU field value or the same MANUFACTURER field value are filtered out and not presented to the user of a catalog in the database.

Those skilled in the art will recognize that the PRODUCT table 504 contains sufficient information to enable the key features of the present invention, namely that of the hierarchical catalog relationships and the updating of product information through a complete hierarchy of channel partner catalogs. The other tables of the database structure shown in FIG. 5 serve to enhance the utility and performance of the catalog functions and update dissemination. Further as noted above, the particular structures and relationships are intended merely as exemplary of one preferred embodiment. Many equivalent structures implemented using any of several storage structures may be used to provide the claimed catalog features and hierarchical relationships among layered marketing channel partners and their respective catalogs. In particular, specific indexing and key fields relating records are intended as exemplary of one preferred embodiment.

Those skilled in the art will further recognize that a variety of performance enhancements are appropriate in particular implementations. For example, depending on the particular application of the present invention particular layers of catalogs may be significantly larger than other layers of catalogs. It may be advantageous in such circumstances to partition the various tables in accordance with features of the particular selected RDBMS. Or, for example, particular tables or indices may be locked for storage in higher performance caching memories of a particular RDBMS. Such performance tuning features and capabilities are well-known to those skilled in the art and represent standard design choices in implementing the present invention.

### Catalog Processing Methods

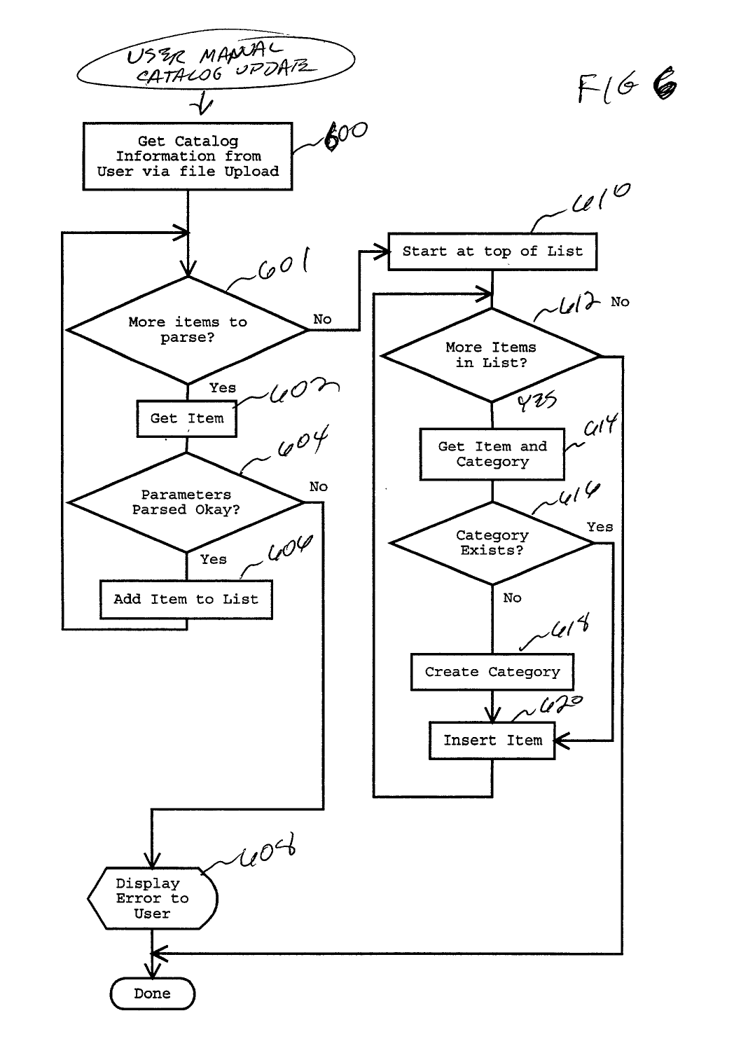

FIG. 6 is a flowchart depicting a method of the present invention to manually load a catalog with product information supplied by a user/owner of the catalog. A user may manually enter information into a catalog as defined above using standard user interface capabilities and database manipulation as well-known in the art. The method of FIG. 6 is exemplary of typical manual management operations used by an owner of the catalog to maintain the catalog contents. Similar procedures will be readily apparent to those skilled in the art to add, delete, or change categories or relations of products to categories, attributes of products, etc. FIG. 6 is therefore intended merely as exemplary of one such typical manual maintenance process.

Element 600 is first operable to obtain identification information from the user to select a particular catalog for updating. In the preferred embodiment a user interface “front-end” program acquires the information from the user intended to be added to the catalog. Element 601 then determines if more items (products) have been provided by the user for entry into the catalog database. If more products remain to be processed, element 602 is operable to get the next item provided by the user/owner. Element 604 then parses the users input to determine that all required data is provided and is correct. If the data is correct, element 606 adds the user defined product information to a list of entries to be added to the catalog and processing continue looping back to element 600. If element 604 determines that the user supplied product information is improper, the list of items is not added to the catalog and processing terminates with element 608 indicating an error to the user. The user then restarts the process and re-enters all data needed to correct the errors.

If element 600 determines that all user input has been processed, element 610 is then operable to get the first item from the list of correctly entered products to be added to the catalog database. If element 612 next determines that no further entries remain on the list, processing terminates having completed processing to add user defined products to the catalog. If items remain on the list to be processed into the catalog, element 614 is operable to retrieve the next item on the list and in particular to identify the product and category defined by the user for the item to be added. Element 616 next determines whether the category selected for the item to be added already exists in the catalog. If so, processing continue with element 620 below. If not, element 618 first adds the newly defined category to the catalog database structure. Element 620 then adds the newly defined item into the products of the catalog database and relates the new entry to the appropriate category and other related records. Processing then loops back to element 612 to complete processing of all items in the list of items to be added.

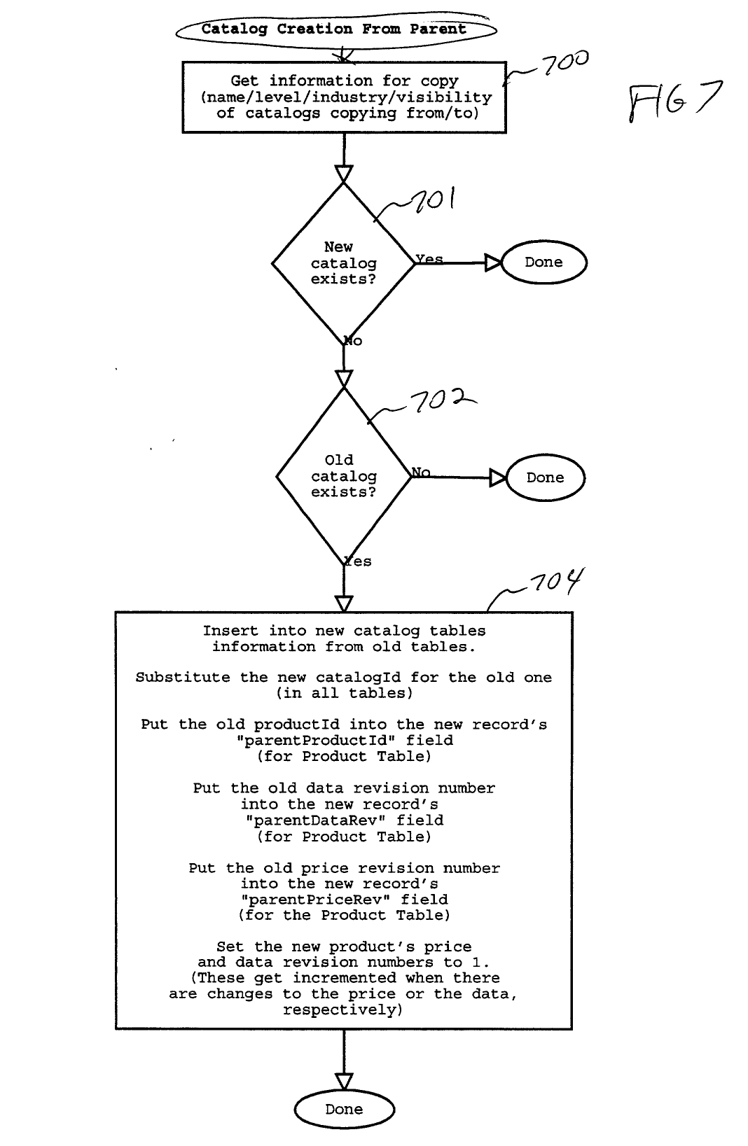

FIG. 7 provides an enabling overview of the processing required to duplicate one catalog's contents into a new catalog. Such a process is typical of copying a catalog from a parent to a child as a starting point for new product information and pricing for a channel partner. Element 700 first obtains identification information from a user of the method to identify a particular catalog to be copied to create a new catalog. Elements 701 and 702 verify that the new catalog to be created does not already exist and that the old catalog to be duplicated. If either test fails, processing is terminated. Otherwise, element 704 copies the entire content of the old (i.e., parent) database to a new child database. Several database records are updated to reflect that the copied database represents a new catalog at a new child layer of the marketing channel hierarchy. The CATALOGID field of all tables copied is modified to a new CATALOGID value. Copy the PRODUCTID values in all product table entries to the PARENTPRODUCTID field of each product table record. Copy THISPRICEREV to PARENTPRICEREV and THISDATAREV to PARENTDATAREV in each record of the product table. Set THISDATAREV and THISPRICEREV to 1 in each record of the new catalog product table. These initializations assure that the pricing and product information of this new child catalog will be updated in accordance with update processing described further herein below.

Those skilled in the art will recognize that element 704 may also selectively copy records from the parent database to the newly created child. For example, a new channel partner catalog database may be created that selects only particular goods or services from manufacturers and/or selects only particular manufacturers. The creation of a new child catalog from a parent may therefore include complete copying of all information in the parent or selective copying of information based on desired selection criteria.

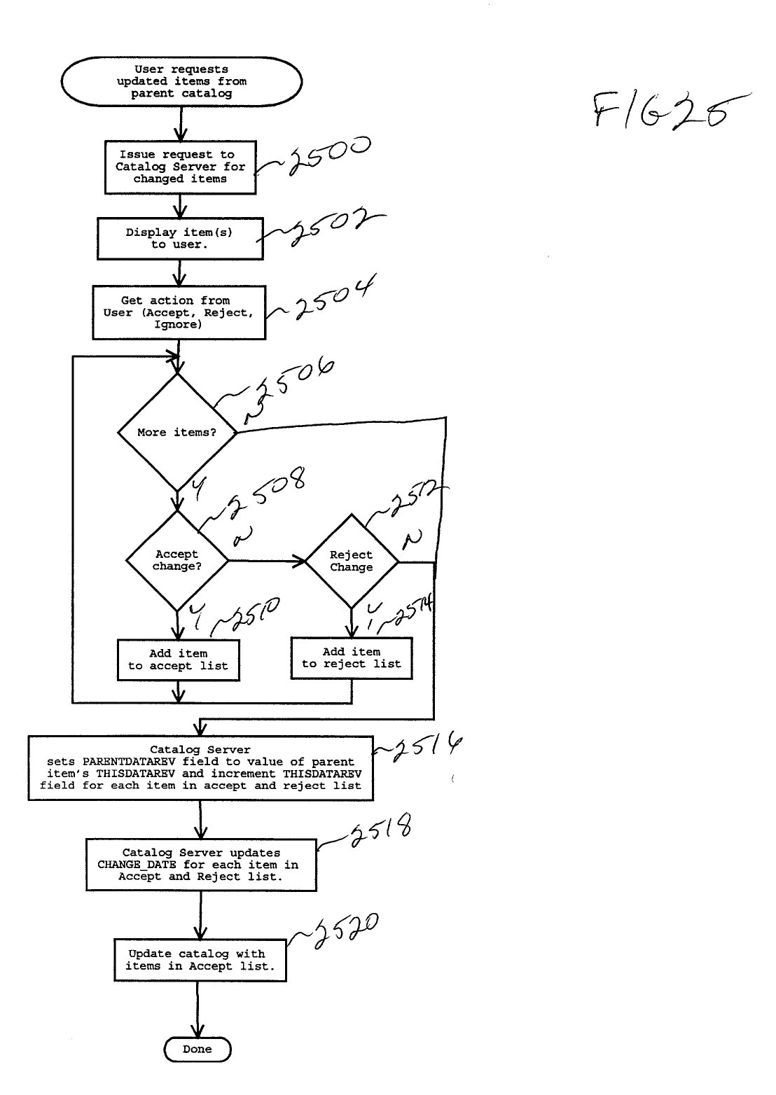

FIG. 25 is a flowchart describing a manual process for updating information in a catalog from its parent catalog. Those skilled in the art will recognize, as noted above, that such update processing may be automated on a periodic basis rather than performed as shown here as a manual process. Such automation and periodic operation may be implemented using well-known scripting and task scheduling features common in most computer operating systems.

Element 2500 is first operable to request of the catalog server process a list of all changed items from the parent catalog of the catalog to be updated. Element 2502 then presents all such changed items in the parent catalog to the user for further action. Element 2504 obtains the users desired action for each changed item.

Elements 2506 through 2514 are then iteratively operable to determine the desired action for each item presented to the user. Specifically, element 2506 determines when all changed items presented to the user have been processed. When so completed, processing completes at element 2516 below. Otherwise, element 2508 determines whether the user has accepted the changed item for inclusion in the catalog. If so, the item is added to an accepted list at element 2510 and processing continues by looping back to element 2506. If the changed item has not been accepted, element 2512 determines whether the user intended to reject the changed item from inclusion in the catalog to be updated. If not, processing terminates with element 2516 below. If the user intended to reject the updated item, element 2514 adds the item to a list of items rejected from inclusion in the catalog to be updated and processing continues by looping back to element 2506.

Element 2516 is operable when all user responses have been processed. Element 2516 updates the product data revision information in the catalog to be updated for each item accepted or rejected in the user's responses above. The product data revision is updated by setting the PARENTDATAREV field in the product entry of this catalog to the value of the parent item's THISDATAREV field and then incrementing the THISDATAREV field of the product entry in this catalog.

Element 2518 then updates the CHANGE_DATE field for each item accepted or rejected in the user's responses.

Lastly, element 2520 updates the product information in this catalog for each updated item accepted by the user for inclusion in this catalog.

FIG. 25 is an exemplary preferred embodiment of an integrator or integration means that integrates updated information from a parent catalog into a child catalog. In this exemplary integrator or integration means, pricing or other product information is selected from a parent catalog based on revision information and integrated into the child catalog. This particular integration is performed under the manual control of a user. As noted above, the process may also be performed automatically using timed event processing and scripting controls as well-known in present computing systems.

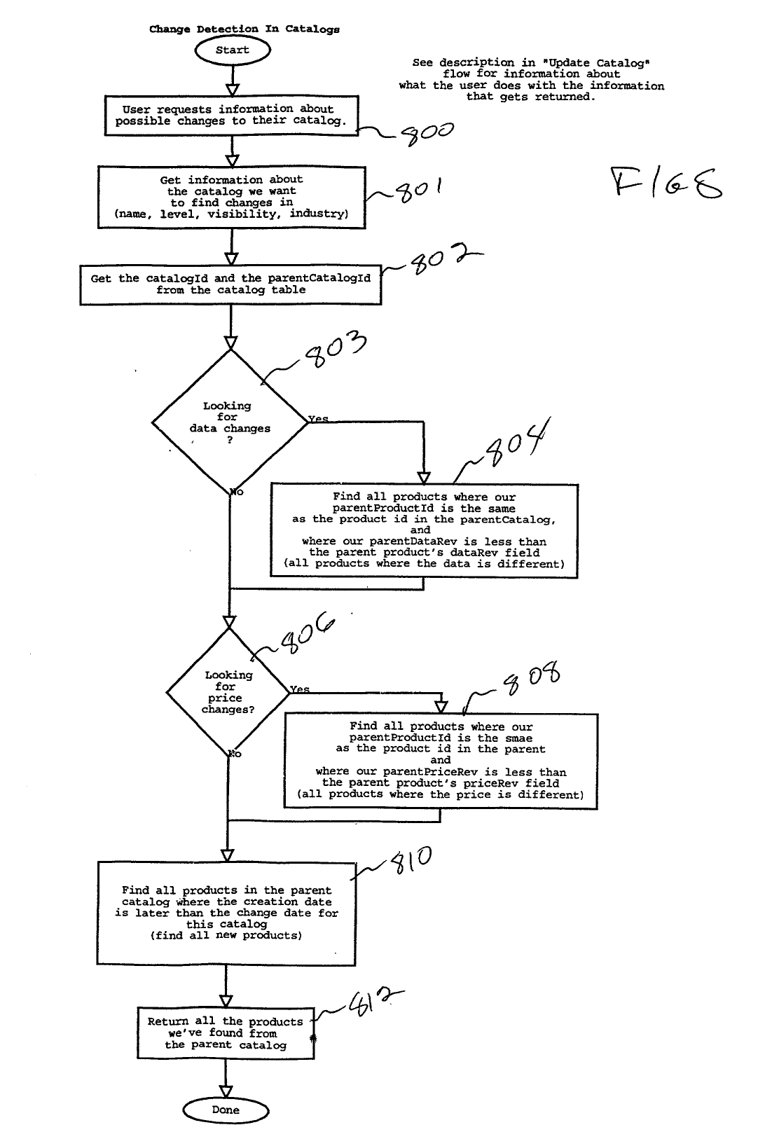

Element 2500 of FIG. 25 shows the detection of changed items in the parent catalog. FIG. 8 is a flowchart describing details of processing to detect changes in the parent catalog. Element 800 represents the invocation of the method of FIG. 8 by a user such as element 2500 above in FIG. 25. As noted herein, the update processing may be invoked by a manual process or may be invoked by automated, periodic operations. Element 801 is then operable to get information about the parent catalog to be queried for changes and element 802 obtains the CATALOGID and PARENTCATALOGID from the catalog to be updated. Element 803 then determines whether the process is to check for updates to product information (other than pricing information). If not, processing skips ahead to element 806. If so, element 804 locates all records in the parent catalog (using the PARENTCATALOGID as a key value to locate records in the parent catalog) that may have updated product information. Specifically, the query locates all records in the PRODUCT table of the parent catalog where the PARENTPRODUCTID in a record of the product table of the child matches the PRODUCTID in the parent's PRODUCT table and where the PARENTDATAREV in such a record of the child catalog is less than the THISDATAREV of the parent catalog's matching record. All such located records are recorded in a list for later processing. Processing then continues with element 806.

Element 806 determines whether the process is to check for updates to product pricing information. If not, processing skips ahead to element 810. If so, element 808 locates all records in the parent catalog (using the PARENTCATALOGID as a key value to locate records in the parent catalog) that may have updated product pricing information. Specifically, the query locates all records in the PRODUCT table of the parent catalog where the PARENTPRODUCTID in a record of the product table of the child matches the PRODUCTID in the parents PRODUCT table and where the PARENTPRICEREV in such a record of the child catalog is less than the THISPRICEREV of the parent catalog's matching record. All such located records are recorded in the list for later processing.

Element 810 is next operable to locate all records in the parent catalog's PRODUCT table where the CREATE_DATE is newer than the CHANGE_DATE of the child catalog's PRODUCT table. All such located records are added to the list for later processing. Element 812 returns all located items on the list to a requester for further processing. The further processing may include automated update of pricing information and/or product information or may involve manual processing to select which located updated records will be copied to the child catalog.

FIG. 8 is another exemplary preferred embodiment of a selector or selection means that selects records having updated information from a parent catalog based on revision data. This exemplary selector or selection means is operable as described above to select changes based on pricing revision indices and/or product data revision indices. Those skilled in the art will recognize a variety of equivalent methods and structures that may effectuate the purpose of selecting updated information from a parent catalog.

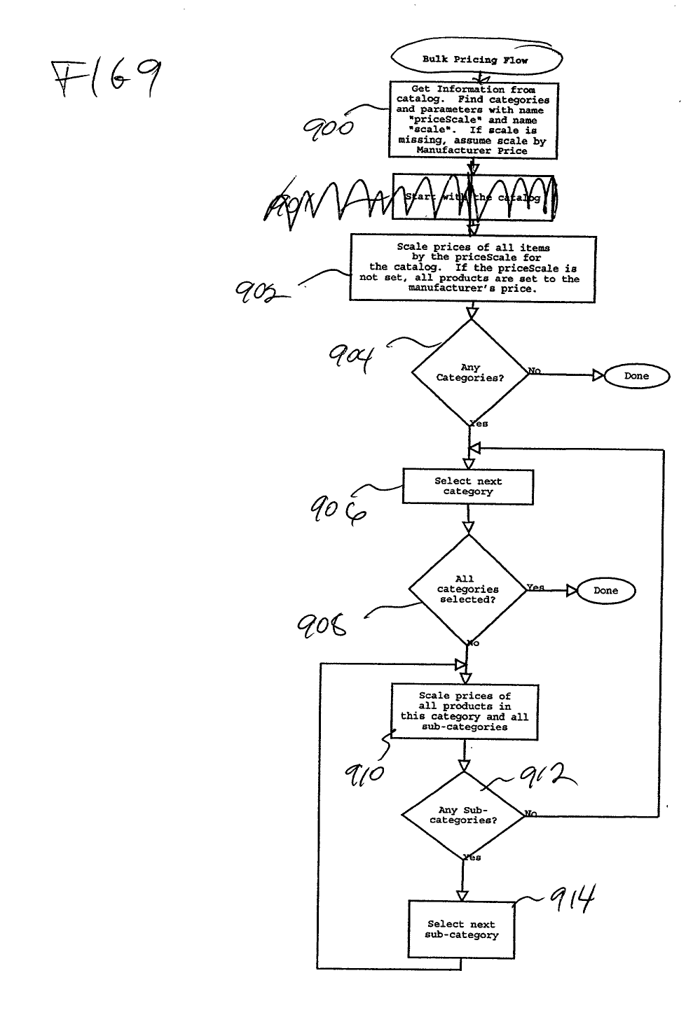

A valuable aspect of the present invention lies in the ability to perform automated scaling of prices in a catalog as prices are updated as discussed above with respect to FIG. 8. FIG. 9 is a flowchart that describes a method of the present invention that utilizes the catalog database structure of FIG. 5 to provide automated updating and scaling of prices in a catalog of the database. Element 900 is first operable to find all products and categories in the catalog to be updated having a related parameter that has a parameter NAME field of “PRICESCALE.” Element 902 then scales the prices of all products in the catalog. For those products having a PRICESCALE parameter related thereto, the VALUE field of the PRICESCALE parameter is used as the scale factor (percentage increase or decrease) applied to a base price. The base price used is the manufacturers price for the product from the parent catalog unless the product also has a parameter with a NAME field of “SCALE.” In such a case, the VALUE field of the SCALE parameter identifies a different base price to which the scale factor is to be applied. If there is no PRICESCALE parameter associated with a product, it's price is simply set to the manufacturer's price for the product in the parent catalog.

Element 904 then determines if there are any categories in the catalog that have a related PRICESCALE parameter. If there are none, the price update with scaling process is complete. If there are such categories, processing continues with element 906. Elements 906 through 914 are iteratively operable to apply price updating and scaling to categories of products having a related PRICESCALE attribute. Element 906 selects the next category having a related PRICESCALE attribute. Element 908 determines if all such categories have been processed. If so, processing is complete. If not, element 910 is operable to update and scale the prices of all products in this category as discussed above with respect to element 902. Element 912 then determines whether the category has any sub-categories. If not, processing continues by looping back to element 906. If there are sub-categories, elements 914, 910 and 912 are iteratively operable to update and scale prices as discussed above for all products in the sub-category. When element 912 determines that all sub-categories have been so processes, the method continues at element 906 to process additional categories.

FIG. 9 is another exemplary preferred embodiment of an integrator or integration means that integrates updated information from a parent catalog into a child catalog. In this exemplary integrator or integration means, pricing information is selected from a parent catalog and integrated into the child catalog.

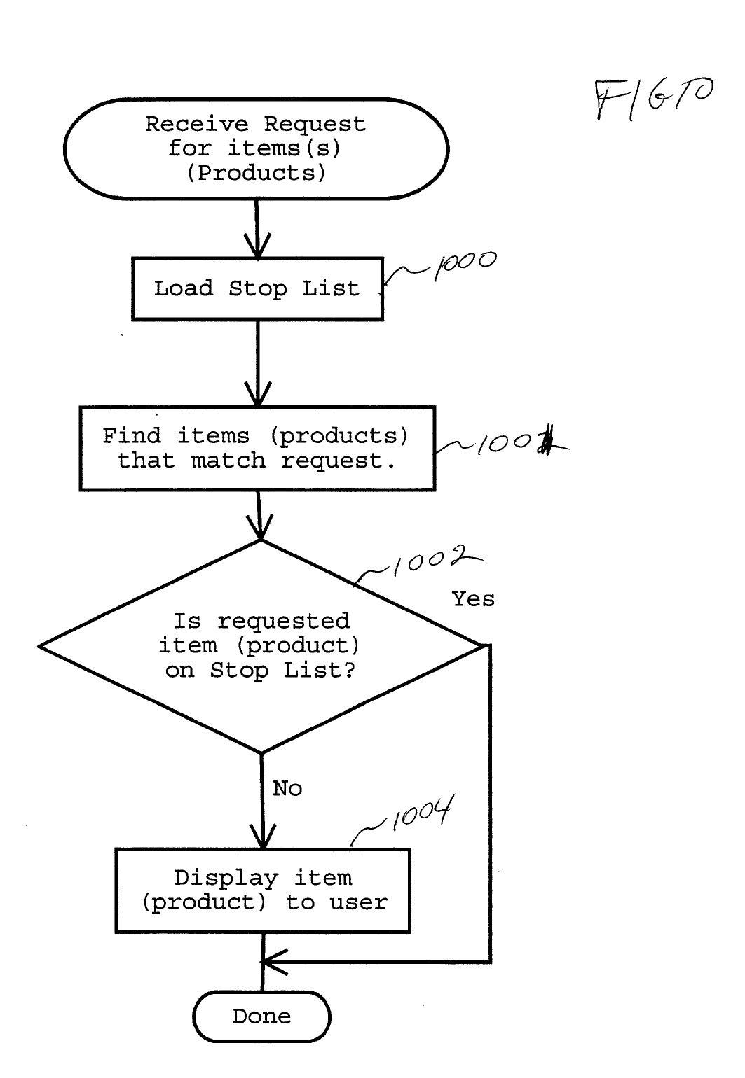

FIG. 10 is a flowchart of a method of the present invention that applies the STOPLIST tables of the database to filter out particular products from the catalog based upon external parameters. Element 1000 first loads an appropriate STOPLIST for the particular user request received. As noted above, a typical application of such stop list processing may be to suppress particular products from particular manufacturers when a user accesses the catalog from a particular portal. Element 1000 therefore loads the appropriate stop list items based on such access criteria. Element 1001 then locates all products (items) associated with the stop list loaded for this particular use of the catalog. Element 1002 then inspects the loaded stop list items to determine if a product otherwise selected for return to the caller is in the list of stop items. If so, the item is not returned. If not, then the selected item is returned to the user or otherwise processed by the requesting process or user. Those skilled in the art will readily recognize that the access of both child and parent catalogs by a single process presumes access to both catalogs from a single process. Such access is well-known to those of ordinary skill in the art through use of client/server technologies in distributed computing environments. Other equivalent programming techniques may be applied to achieve such remote access to a database when a parent or child catalog stored remotely with respect to the process requiring access. Such techniques represent well-known design choices for those of ordinary skill in the art.

### Exemplary Class Diagram

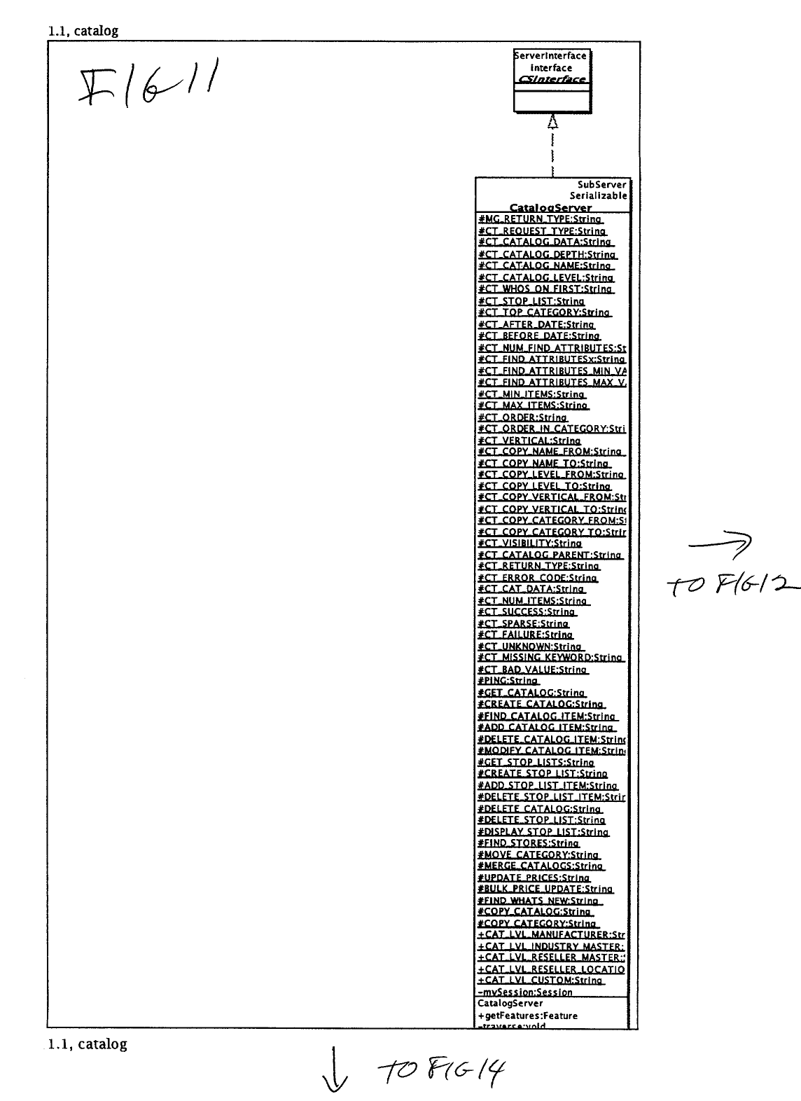

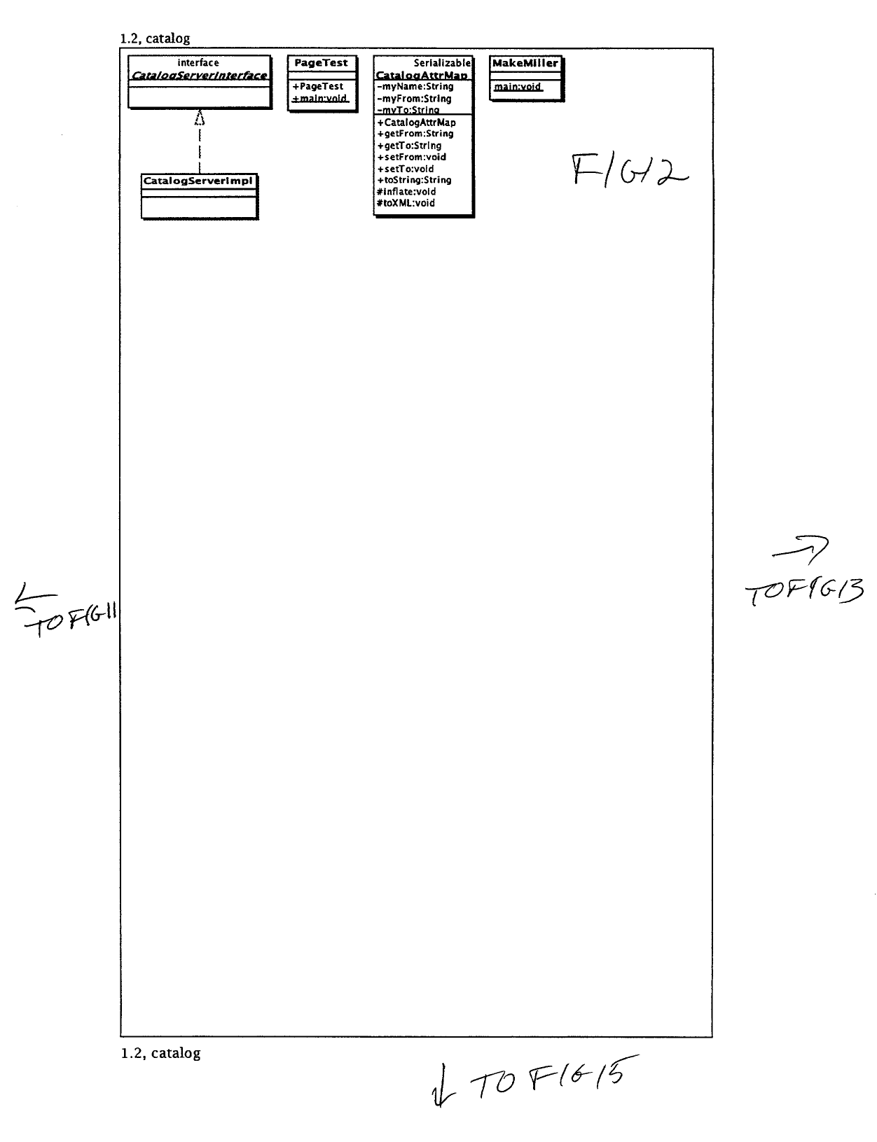

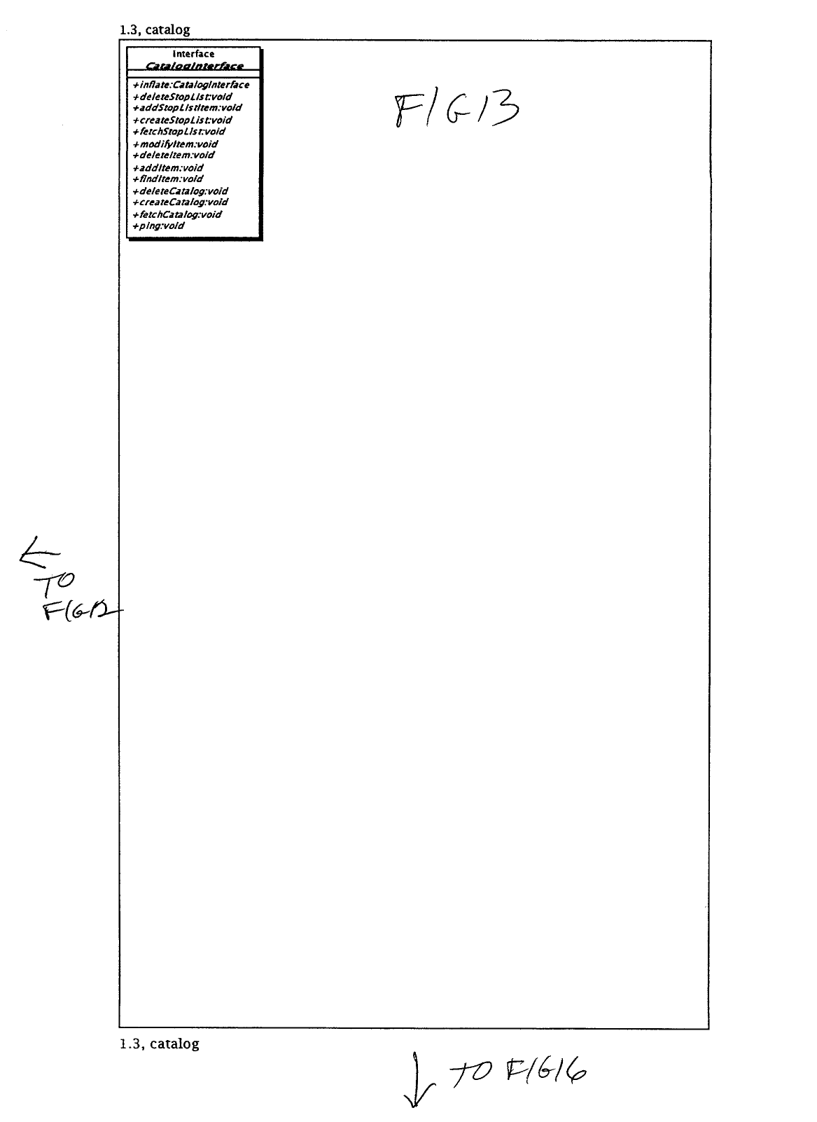

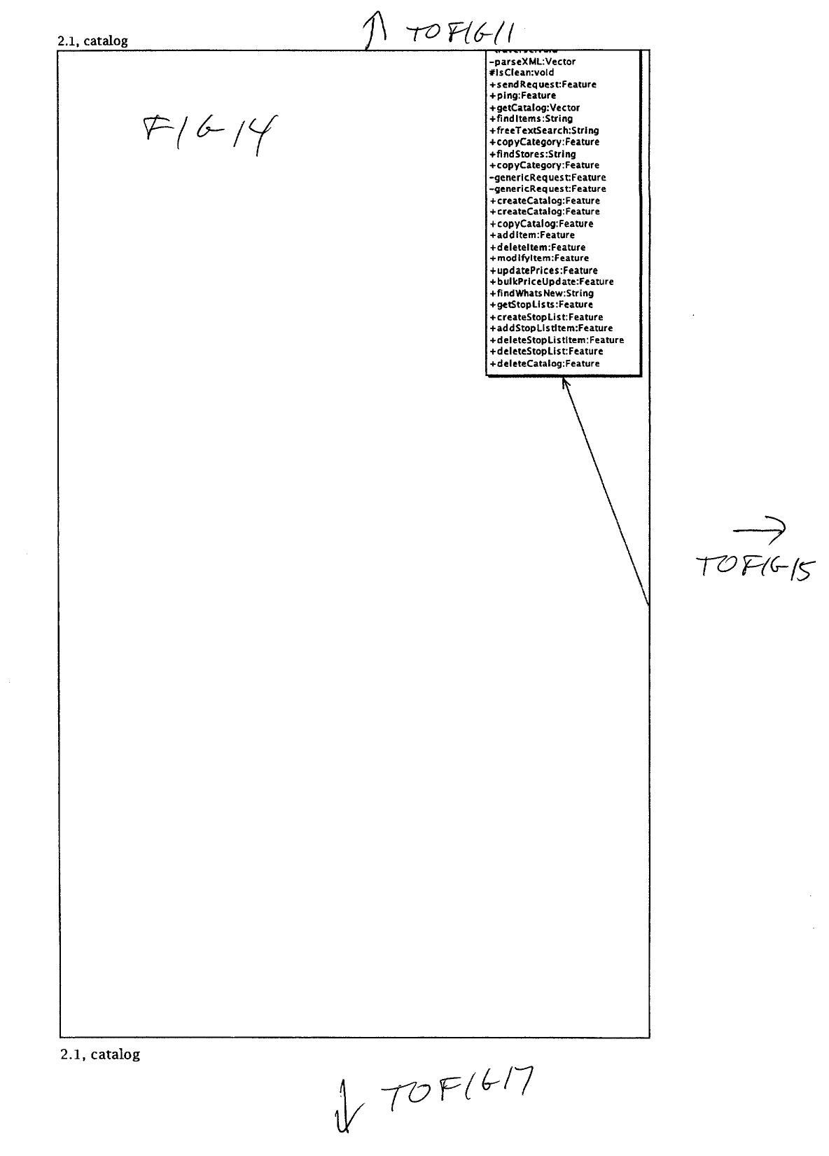

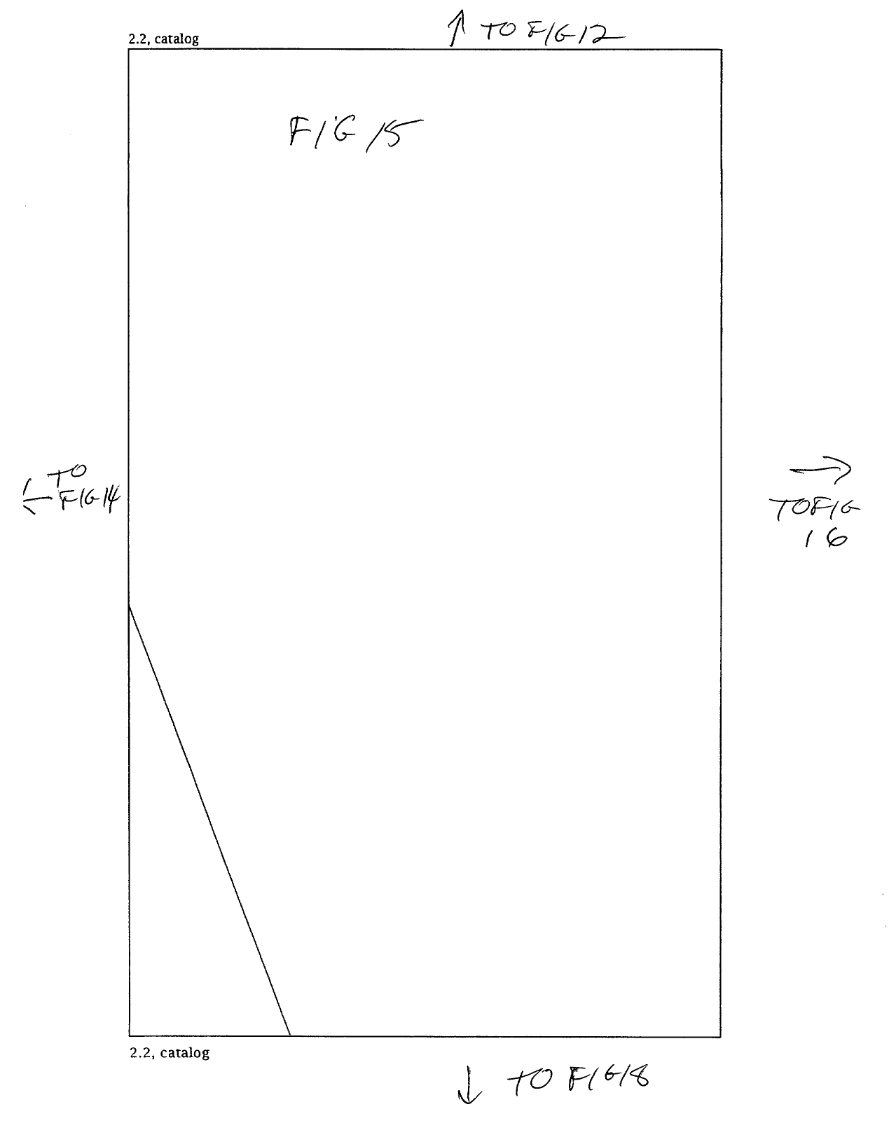

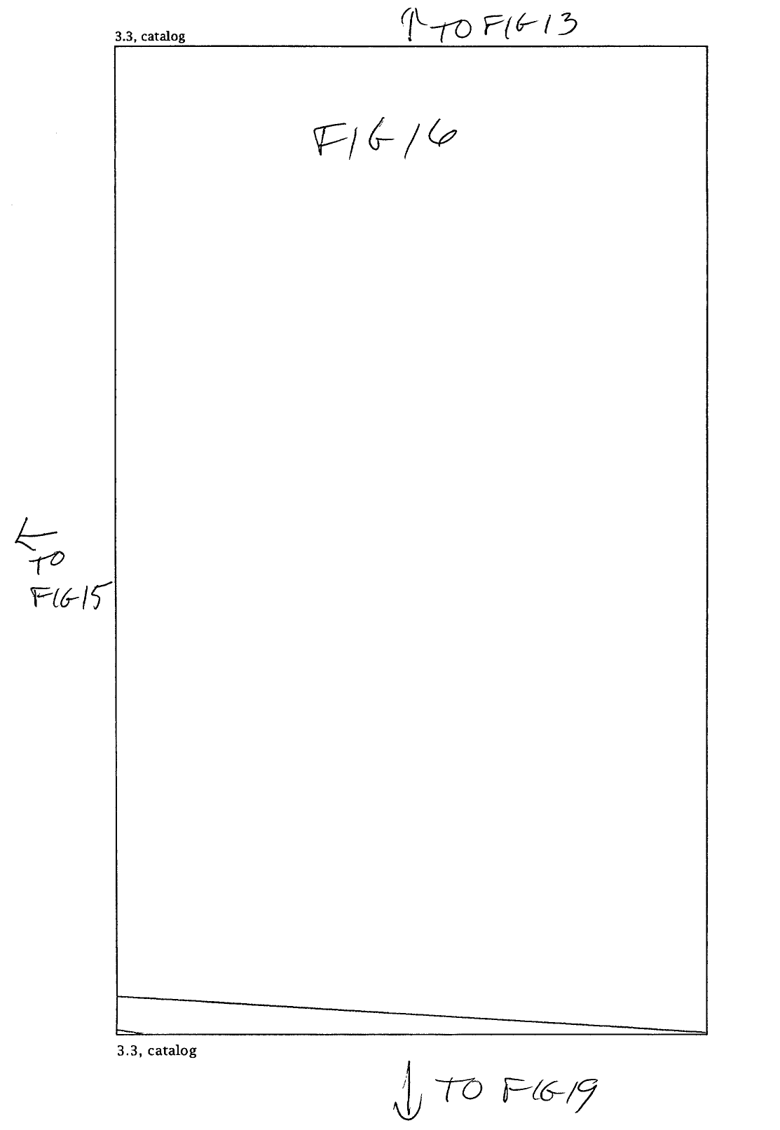

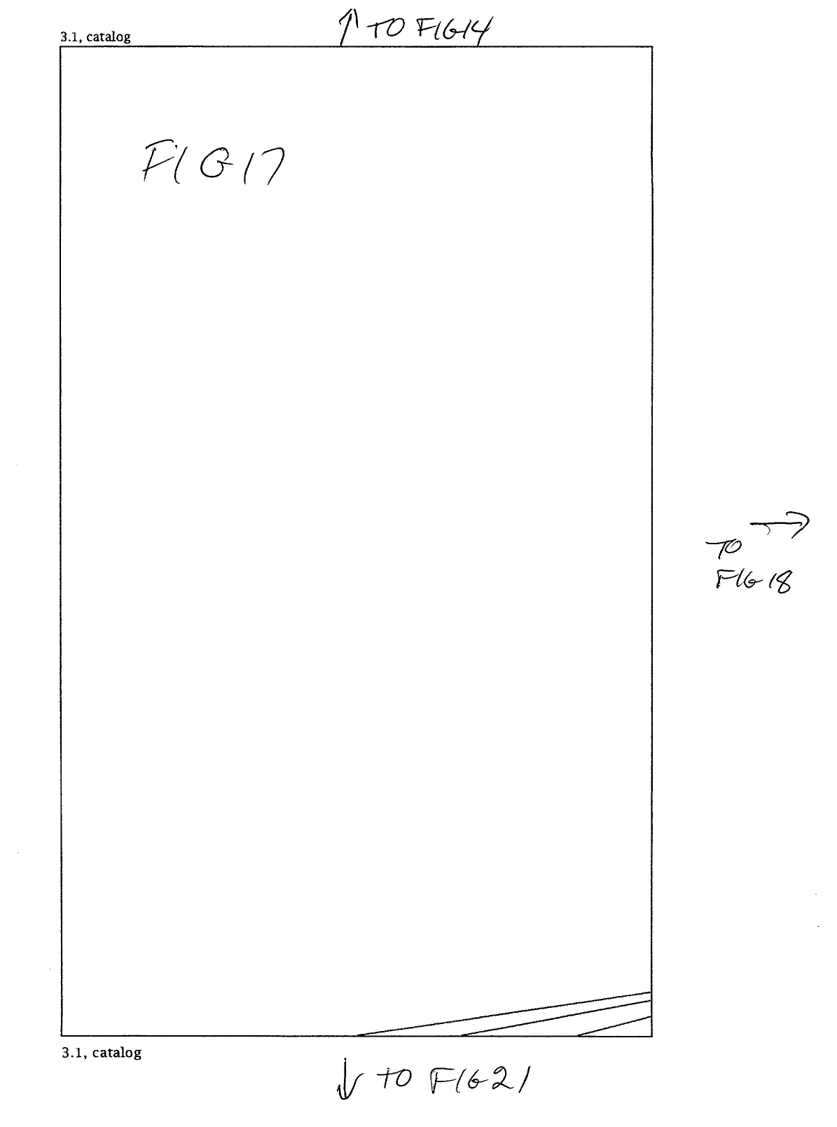

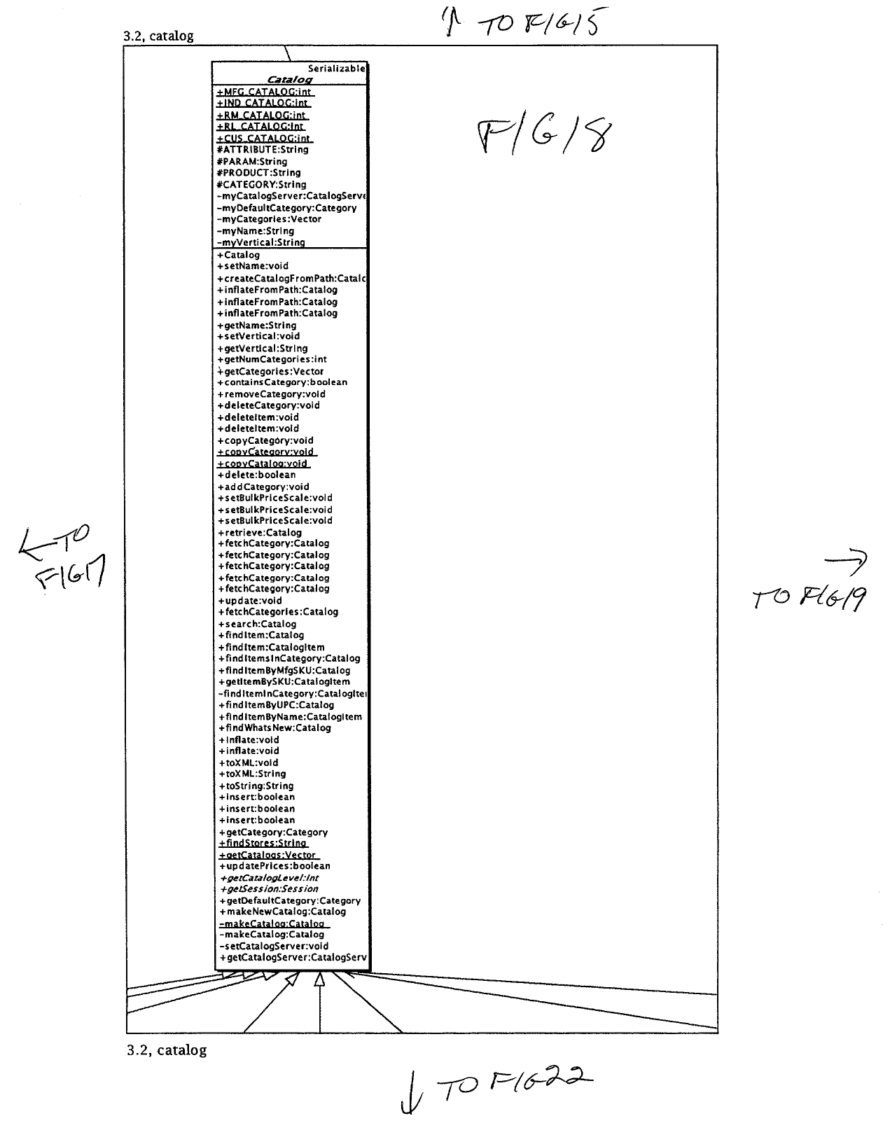

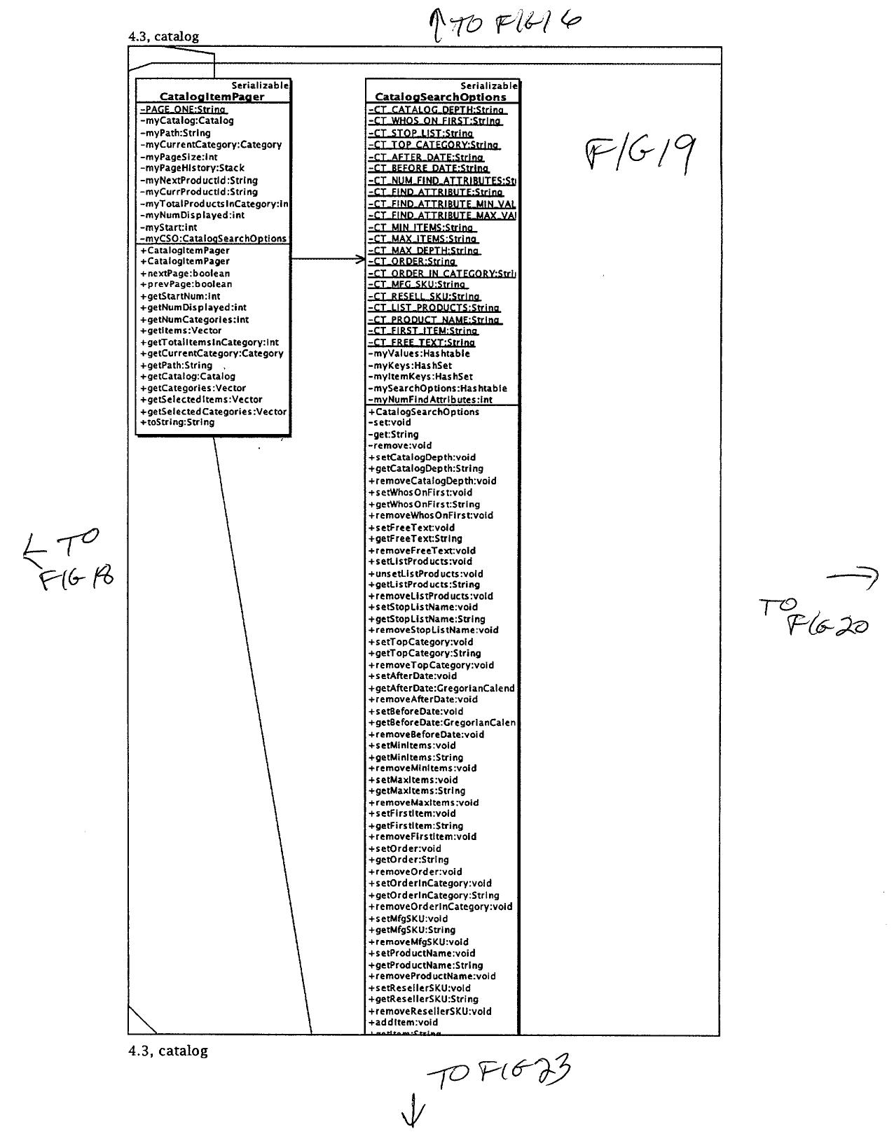

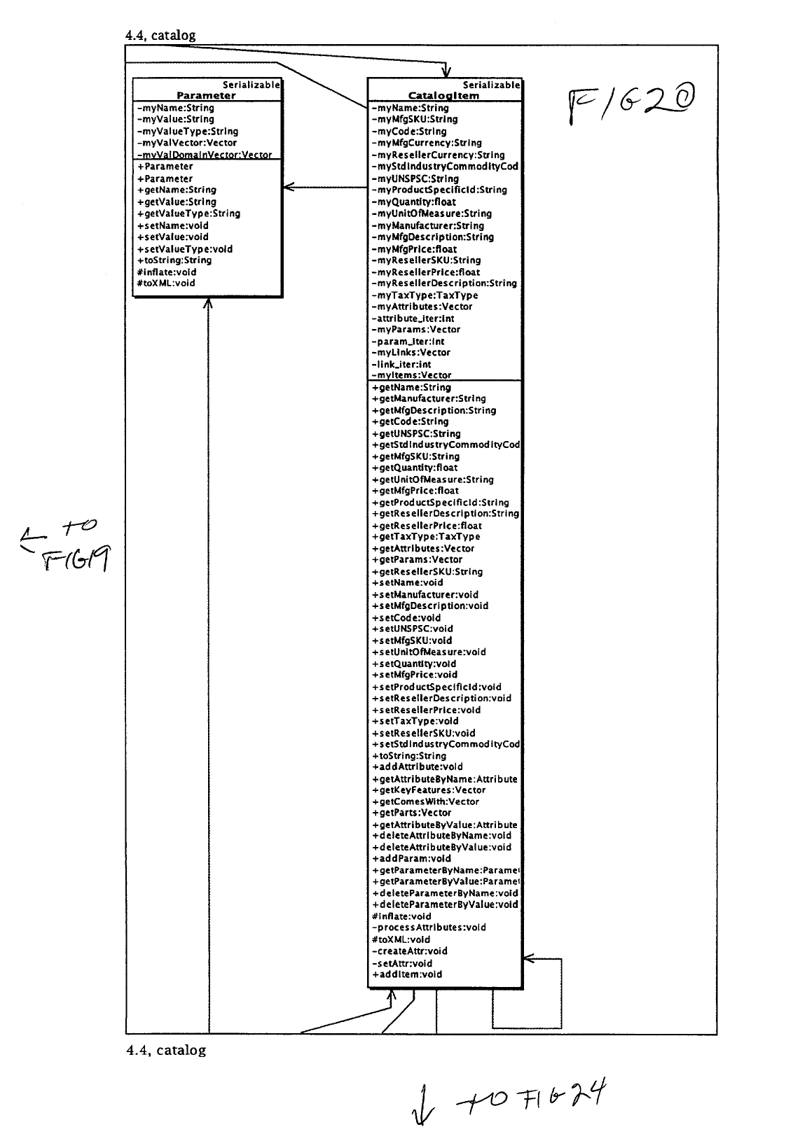

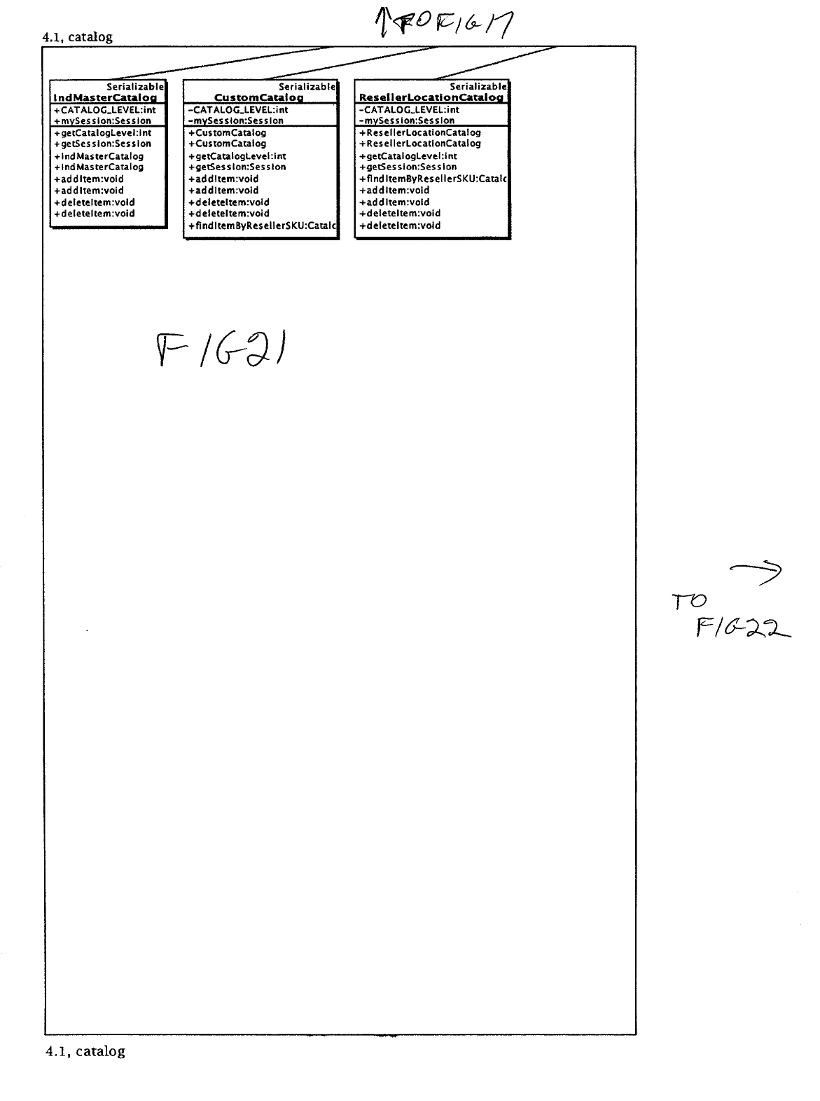

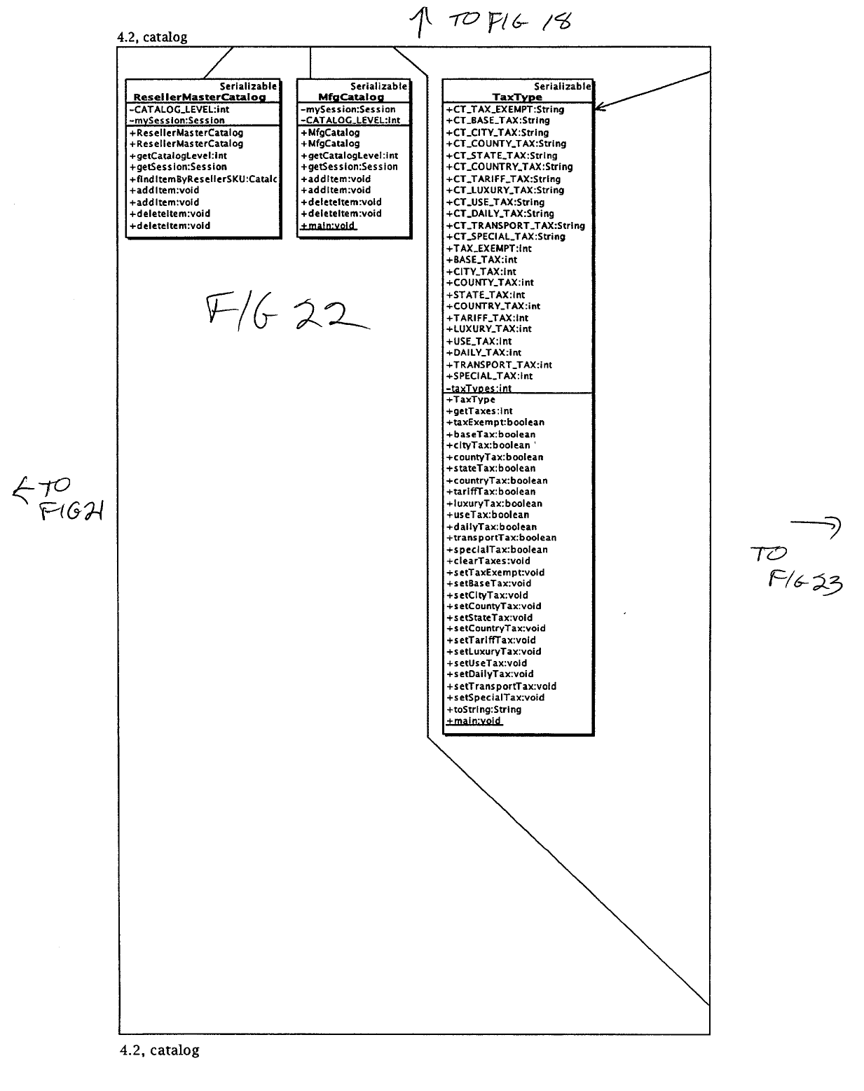

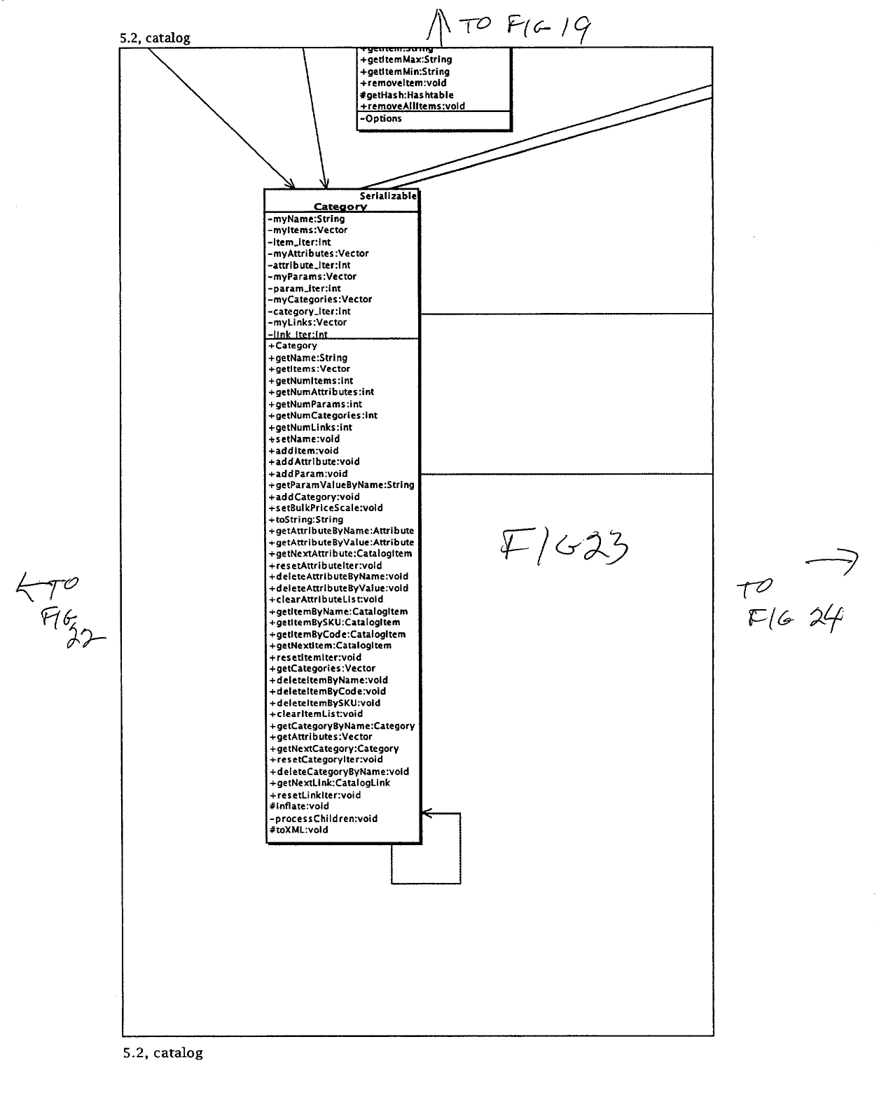

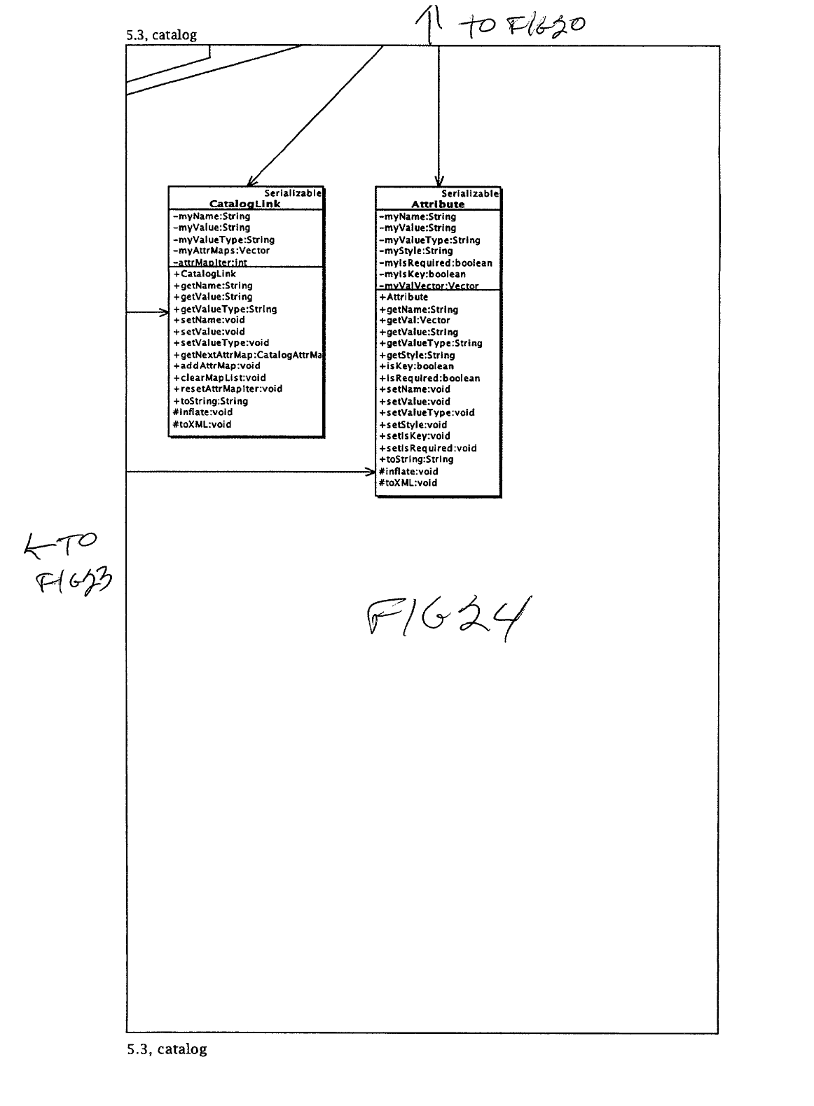

FIGS. 11 through 24 are class diagrams of a specific implementation of the catalog using object oriented class definitions. FIGS. 11 through 24 in combination depict the class definition and relations between the several objects and methods. The various figures each represent a portion of the total class diagram drawing generated by a typical object oriented design tool. The complete drawing is too large for a single diagram. Each figure is therefore labeled at its edges to indicate the neighboring figure to placed adjacent each figure at that labeled location.

The class diagram shown in FIGS. 11 through 24 further enables one of ordinary skill in the art to practice the invention. A wide variety of implementations will be readily apparent to those skilled in the art including the object-oriented implementation depicted in the class diagram of FIGS. 11 through 24.

While the invention has been illustrated and described in detail in the drawings and foregoing description, such illustration and description is to be considered as exemplary and not restrictive in character, it being understood that only the preferred embodiment and minor variants thereof have been shown and described and that all changes and modifications that come within the spirit of the invention are desired to be protected.

What is claimed is:

1. A catalog system for an electronic commerce channel marketing scenario having a plurality of manufacturers and a plurality of channel partners, said system comprising:
a plurality of manufacturer catalogs, each manufacturer catalog of said plurality of manufacturer catalogs including information regarding products provided by a corresponding manufacturer of the plurality of manufacturers;
an industry catalog generated from selected information received from said plurality of manufacturer catalogs; and
a plurality of channel partner catalogs generated from selected information received from said industry catalog, each channel partner catalog of said plurality of channel partner catalogs associated with a corresponding channel partner of the plurality of channel partners.

2. The system of claim 1 having a plurality of resellers and further comprising:
a plurality of reseller catalogs generated from selected information received from said plurality of channel partner catalogs, each reseller catalog of said plurality of reseller catalogs associated with a corresponding reseller of the plurality of resellers wherein said plurality of reseller catalogs are accessible to end customers.

3. The system of claim 1 wherein:
said industry catalog has a plurality of entries representing said selected information received from said plurality of manufacturer catalogs; and
wherein each entry of said plurality of entries includes revision indices.

4. The system of claim 3 wherein said each channel partner catalog includes:
a selector for determining which information in said industry catalog is newer than information in said each channel partner catalog in accordance with said revision index in said each entry of said industry catalog.

5. The system of claim 4 wherein said each channel partner catalog includes:
an integrator for selectively integrating into said each channel partner catalog information determined to be newer in said industry catalog.

6. The system of claim 3 wherein said revision index includes a price revision index value.

7. The system of claim 6 wherein said price revision index in each catalog includes a child price revision index value an a parent price revision index value and wherein said parent price revision index of a product in a first catalog is compared to said child price revision index value of a corresponding product in a parent catalog from which said first catalog is generated to determine whether corresponding pricing information in said parent catalog is newer than corresponding pricing information in said first catalog.

8. The system of claim 3 wherein said revision index includes a product data revision index value.

9. The system of claim 8 wherein said product data revision index in each catalog includes a child product data revision index value an a parent product revision index value and wherein said parent product data revision index of a product in a first catalog is compared to said child product data revision index value of a corresponding product in a parent catalog from which said first catalog is generated to determine whether corresponding product data information in said parent catalog is newer than corresponding product data information in said first catalog.

10. The system of claim 1 wherein each catalog of said system includes:
a stoplist to identify products in a corresponding catalog to be excluded from presentation to a requesting user.

11. The system of claim 1 having a plurality of resellers and further comprising:
a plurality of reseller catalogs generated from selected information received from said plurality of channel partner catalogs, each reseller catalog of said plurality of reseller catalogs associated with a corresponding reseller of the plurality of resellers; and
at least one end customer catalog generated from selected information received from a reseller catalog of said plurality of reseller catalogs wherein said end customer catalog is accessible to end customers.

12. A method for manipulating product catalogs in a channel marketing scenario having a plurality of manufacturers and a plurality of channel partners, said method comprising the steps of:
providing an industry master catalog having an aggregation of a plurality of manufacturer catalogs, each manufacturer catalog of said plurality of manufacturer catalogs including information regarding products or services available from a corresponding manufacturer of said plurality of manufacturers; and
selectively copying portions of said industry master catalog to a plurality of channel partner catalogs, each channel partner catalog of said plurality of channel partner catalogs representing goods or services of a manufacturer available from a corresponding channel partner of said plurality of channel partners.

13. The method of claim 12 further comprising the steps of:
detecting changed information in said plurality of manufacturer catalogs; and
periodically updating said industry master catalog from said changed information in said plurality of manufacturer catalogs.

14. The method of claim 13 wherein the step of detecting includes the step of:
determining whether information in said plurality of manufacturer catalogs is newer than corresponding information in said industry master catalog based on a revision index value in said plurality of manufacturer catalogs and a corresponding revision index value in said industry master catalog.

15. The method of claim 14 wherein said revision index value includes a price revision index value.

16. The method of claim 14 wherein said revision index value includes a product data revision index value.

17. The method of claim 12 further comprising the steps of:
detecting changed information in said industry master catalog; and
periodically updating said plurality of channel partner catalogs from said changed information in said industry master catalog.

18. The method of claim 17 wherein the step of detecting includes the step of:
determining whether information in said industry master catalog is newer than corresponding information in said plurality of channel partner catalogs based on a revision index value in said plurality of channel partner catalogs and a corresponding revision index value in said industry master catalog.

19. The method of claim 18 wherein said revision index value includes a price revision index value,

20. The method of claim 18 wherein said revision index value includes a product data revision index value.

21. The method of claim 12 further comprising the step of:
periodically updating and scaling pricing information for all products in said industry master catalog based on corresponding pricing information in said plurality of manufacturer catalogs and based on price scaling information in said industry master catalog.

22. The method of claim 12 further comprising the step of:
periodically updating and scaling pricing information for all products in said plurality of channel partner catalogs based on corresponding pricing information in said plurality of industry master catalog and based on price scaling information in said plurality of channel partner catalogs.

23. The method of claim 12 further comprising the steps of;
locating information in a channel partner catalog of said plurality of channel partner catalogs in response to a request from a user using an identified portal;
filtering the located information to remove restricted information based on said identified portal used by said user; and
returning the filtered information to said user.

24. The method of claim 12 further comprising the step of:
selectively copying portions of at least one channel partner catalog of said plurality of channel partner catalogs to a reseller catalog wherein said reseller catalog is accessible to an end customer.

25. The method of claim 12 further comprising the steps of:
selectively copying portions of at least one channel partner catalog of said plurality of channel partner catalogs to a reseller catalog; and
selectively copying portions of said reseller catalog to an end customer catalog wherein said end customer catalog is accessible to an end customer.

26. A system hierarchical product catalogs in a multi-layer channel partner marketing scenario comprising:
a plurality of top layer catalogs each containing information regarding products associated with an owner of the corresponding top layer catalog of said plurality of top layer catalog; and
a plurality of child catalogs wherein each child catalog of said plurality of child catalogs contains information generated from selected information received from a parent catalog wherein said parent catalog is top layer catalog of said plurality of top layer catalogs or wherein said parent catalog is another child catalog of said plurality of child catalogs.
